(19) United States
(12) Patent Application Publication
(10) Pub. No.: US 2014/0200001 A1
(43) Pub. Date: Jul. 17, 2014

(54) METHOD AND APPARATUS FOR MOBILITY ENHANCEMENT

(71) Applicant: RESEARCH IN MOTION LIMITED, Waterloo (CA)

(72) Inventors: Yi Song, Plano, TX (US); Chandra Sekhar Bontu, Nepean (CA); Zhijun Cai, Euless, TX (US); Przemyslaw Czerepinski, Bristol (GB)

(73) Assignee: Research In Motion Limited, Waterloo (CA)

(21) Appl. No.: 13/742,181

(22) Filed: Jan. 15, 2013

(51) Int. Cl. H04W 8/02

(52) U.S. Cl. CPC H04W 8/02
USPC 455/436; 455/422.1

(57) ABSTRACT

Systems, apparatuses, and methods for a radio resource management (RRM) decision in wireless communication network are provided. In particular, post-processing metric is introduced in RRM decision making. Certain aspects of the disclosure involve, a method, performed at a user equipment (UE) of a wireless communications network. The method includes receiving a reference signal from a network node, processing the reference signal based on a receiver processing algorithm, identifying a post-processing metric based at least in part on the received reference signal, and triggering a mobility event based at least in part on the post-processing metric.

### FIELD

This disclosure relates to radio resource management such as mobility support in cellular wireless networks, and more particularly, in heterogeneous networks.

### BACKGROUND

Wireless communication systems can include a network of one or more base stations to communicate with one or more user equipment (UE) such as fixed and mobile wireless communication devices, mobile phones, or laptop computers with wireless communication cards. Base stations are spatially distributed to provide radio coverage in a geographic service area that is divided into cells. A UE that is located within a base station's coverage area is generally registered with the base station. The UE and the base station communicate with each other via radio signals. The base station is called the serving base station of the UE and the cell associated with the base station is called the serving cell of the UE.

In some wireless networks, cells of different coverage sizes may be deployed to improve cell coverage or to offload traffic. For example, small cells (e.g., pico cells, relay cells, or femto cells) may be deployed with overlaid macro cells. A network including large cells (e.g., macro cells) as well as small cells (e.g., pico cells, relay cells, femto cells) may be referred to as a heterogeneous network. A UE in the heterogeneous network may move in a large geographical area which may trigger a mobility event. Radio resource management decisions may need to be made to support UE mobility in wireless communication networks.

### BRIEF DESCRIPTION OF DRAWINGS

FIG. 1 is a schematic representation of an example heterogeneous wireless communications network.

FIG. 2 is a schematic block diagram illustrating various layers of access nodes and user equipment in a wireless communication network.

FIG. 3 is a schematic block diagram illustrating an access node device.

FIG. 4 is a schematic block diagram illustrating a user equipment device.

FIG. 5 is a block diagram illustrating an example receiver.

FIG. 6 is a schematic presentation of an example deployment where enhanced inter-cell interference coordination (eICIC) may be used.

FIG. 7 is a schematic presentation of another example deployment where eICIC may be used.

FIG. 8 is schematic presentation of an example of almost blank subframe (ABS) patterns.

FIG. 9 is a flow chart illustrating an example method may be performed by a UE.

FIG. 10 is a flow chart illustrating an example method may be performed by a network node.

FIG. 11 is a flow chart illustrating an example signal flow of measurement report triggering based on feedback from a UE.

FIG. 12 is a flow chart illustrating an example signal flow of measurement report triggering based on post-processing signal quality measurement at a UE when the UE is moving from a pico cell range extension area to a macro cell.

FIG. 13 is a flow chart illustrating an example signal flow of measurement report triggering based on post-processing signal quality measurement at a UE when the UE is moving from a macro cell to a pico cell range extension area.

FIG. 14 is a schematic block diagram illustrating an example HetNet scenario.

FIG. 15 is a schematic block diagram illustrating another example HetNet scenario.

### DETAILED DESCRIPTION

The present disclosure is directed to systems, methods, and apparatuses for handover in wireless communications networks, especially in heterogeneous wireless communication networks. Heterogeneous networks are designed to provide a balance of coverage needs and capacity. A heterogeneous network (HetNet) may include cells of various coverage sizes resulting at least in part from different transmission power levels of base stations, e.g., macro cell, femto cell, pico cell, relay cell, etc. The macro cells may overlay the low power nodes, sharing the same frequency or different frequencies. Low power cells can be used to offload communication traffic from macro cells, improve indoor and cell edge performance, etc. The 3rd Generation Partnership Project (3GPP) studies HetNet as a performance enhancement enabler in LTE (Long Term Evolution)-Advanced (Release 10) and UTRA (UMTS Terrestrial Radio Access) (Release 12).

As the UE moves across cell boundaries, a mobility event may be triggered to ensure that the UE is connected to or camped on a cell with good coverage for the UE. A mobility event can include one or more of a cell selection or reselection event, a measurement report triggering event, or any other appropriate radio resource management (RRM) related event. RRM decisions such as handover or cell selection/reselection may need to be made to support UE mobility. The mobility event may be triggered based on a metric such as a received signal quality or a representation of the received signal quality. The UE may continue to measure the received signal quality according to the measurement configurations configured by the eNB. The received signal quality may be obtained, for example, by measuring at least one of many received signal parameters such as, the received signal strength, received signal to interference signal to interference plus noise ratio, packet error rate etc. The signal quality measured over the received signals at the output of one or more of the receive antenna ports. The signal quality may also be measured over a received signal, which is obtained as result of processing all the received signals at the output of one or more of the receive antenna ports. The method of processing received signals is typically dependent on the UE's receiver algorithm. When certain criteria is met, the UE may report the measured results to the eNB. The criteria may for example include a combination of received signal parameters approaching a network communicated signal quality thresholds. As different UEs may be equipped with different receivers, the UEs may have different receive capabilities/performances. A receiver may be classified into a simple/baseline or an advance receiver depending at least in part on the receiver's receiving algorithm implementation. For example, a receiver with an advanced receiving algorithm can be classified as an advanced receiver. For UEs with advanced receivers, these UEs can have better post-processing signal quality than UEs with baseline receivers, even though they may share the same pre-processing signal quality. At least to account for the receiving capability/performance of the UE, a post-processing metric can be included in radio resource management (RRM) decisions making, more particularly, in mobility-related decision making. An UE equipped with an advanced receiver may, for example, use partial set of available receive antennas to process the received signal. The received signal from the partial or full set of the available receive antennas may be combined in a way to cancel or suppress/mitigate the inter-cell interference from the other cells. Examples of such receivers may include the well known interference rejection combining (IRC) receivers, successive interference cancellation (SIC) receivers and any such receivers which use some type of a priori knowledge of signal and interference characteristics and surrounding interference sources. In general, the term “advanced” can include any algorithm that exceeds minimum performance requirements. For example, in UTRA, advanced may be an algorithm that satisfies enhanced performance requirements type 1, 2, 3, and 3i.

One aspect of this disclosure features a method that can be performed at a UE in a wireless communications network. The method may include receiving a reference signal; processing the reference signal based on a receiver processing algorithm; identifying a post-processing metric based at least in part on the received reference signal; and/or triggering a mobility event based at least in part on the post-processing metric.

Another aspect of this disclosure features a method that can be performed at a network node in the wireless communications network. The method includes transmitting a reference signal to a user equipment (UE) of the network; and receiving, from the UE, an indication of a mobility event. The mobility event may be triggered based at least in part on the post-processing metric.

Aspect of the present disclosure pertain to a method performed at a user equipment (UE) of a wireless communications network. The method can include receiving a reference signal. A post-processing metric can be identified based at least in part on the received reference signal. A mobility event can be triggered based at least in part on the post-processing metric.

Aspects of the present disclosure are directed to a user equipment (UE) of a wireless communications network, the UE operable to receive a reference signal. The UE can identify a post-processing metric based at least in part on the received reference signal. The UE can trigger a mobility event based at least in part on the post-processing metric.

Certain aspects of the implementations may also include informing the network that the UE is capable of identifying the post-processing metric.

Certain aspects of the implementations may also include receiving an indication from the network to use the post-processing metric to trigger the mobility event.

In certain implementations, triggering the mobility event comprises the UE performing cell selection or reselection.

In certain implementations, triggering the mobility event comprises performing a handover procedure.

In certain implementations, the post-processing metric represents a performance of a receiver processing algorithm.

In certain implementations, the receiver processing algorithm comprises at least one of a Maximum Ration Combining (MRC) algorithm, a Minimum Mean Square Error (MMSE) algorithm, a MMSE-Interference Rejection Combining (MMSE-IRC) algorithm, an Interference Cancellation (IC) algorithm, or a Rake algorithm.

In certain implementations, the receiver processing algorithm fulfills requirements corresponding to at least one of enhanced receiver type 1, 2, 3, or 3i.

In certain implementations, the post-processing metric represents a signal quality of a combination of signals from one or more receiver antenna ports of the UE.

In certain implementations, the combination of signals represents an optimization based on a cost function, the cost function including an inter-cell interference suppression criteria.

In certain implementations, triggering the mobility event may also include identifying a measurement report trigger event based at least in part on the post-processing metric. A measurement report can be generated and the measurement report can be transmitted to the network.

In certain implementations, the measurement report includes the post-processing metric. In certain implementations, the measurement report trigger event is a Type I event. In certain implementations, the Type I event is triggered when a signal quality of a serving cell of the UE becomes worse than a threshold. In certain implementations, the measurement report trigger event is a Type II event. In certain implementations, wherein the Type II event is triggered when a signal quality of a neighboring cell of the UE exceeds a threshold.

Certain aspects of the implementations may also include receiving, from the network, control information instructing the UE to include one or more neighboring cell measurements into the measurement report. The one or more neighboring cell measurements may be included into the measurement report. The measurement report can be transmitted to a network node.

In certain implementations, identifying a post-processing metric based on the received reference signal comprises measuring a signal quality based on the received reference signal based at least in part on one or more of an estimated channel response between a transmit and receive antenna pair, interference statistics, a block error rate, or a transmission mode.

In certain implementations, the post-processing metric is a measure of traffic channel spectral efficiency.

In certain implementations, the post-processing metric is a measure of control channel demodulation quality.

In certain implementations, the post-processing metric is a measure of reference signal or data channel Signal to Interference plus Noise Ratio (SINR).

In certain implementations, the post-processing metric is a Channel Quality Indicator (CQI).

In certain implementations, the reference signal is received during a subset of subframes.

In certain implementations, the subset of subframes is one of Almost Blank Subframes (ABS) and MBSFN.

Certain aspects of the implementations may also include processing the received reference signal to identify a post-processing metric.

Aspects of the present disclosure pertain to a method performed at a network node of a wireless communications network. The network node can transmit a reference signal to a user equipment (UE) of the network. In some implementations, the UE can be capable of identifying a post-processing metric based at least in part on the transmitted reference signal. The network node can receive, from the UE, an indication of a mobility event. In some implementations, the mobility event can be triggered based at least in part on the post-processing metric.

Certain aspects of the implementations may also include receiving an indication from the UE that the UE is capable of identifying the post-processing metric.

Certain aspects of the implementations may also include transmitting, to the UE, an indication instructing the UE to use the post-processing metric to trigger the mobility event.

In certain implementations, the mobility event comprises a cell selection or reselection event.

In certain implementations, the mobility event comprises performing a handover procedure.

In certain implementations, the post-processing metric represents a performance of a receiver processing algorithm.

In certain implementations, the post-processing metric represents a signal quality of a combination of signals from one or more receiver antenna ports of the UE.

In certain implementations, the combination of signals represents an optimization based on a cost function, the cost function including an inter-cell interference suppression criteria.

In certain implementations, the mobility event is a measurement report trigger event and the indication comprises a measurement report.

Certain aspects of the implementations may also include making a handover decision based at least in part on the measurement report.

In certain implementations, the measurement report trigger event is a Type I event.

In certain implementations, the Type I event is triggered when a signal quality of a serving cell of the UE becomes worse than a threshold.

In certain implementations, the measurement report trigger event is a Type II event.

In certain implementations, the Type II event is triggered when a signal quality of a neighboring cell of the UE becomes better than a threshold.

Certain aspects of the implementations may also include transmitting control information instructing the UE to include one or more neighboring cell measurements into the measurement report.

In certain implementations, the reference signal is transmitted during a subset of subframes.

In certain implementations, the subset of subframes is one of Almost Blank Subframes (ABS) and MBSFN.

Certain aspects of the disclosure pertain to systems, methods performed at a user equipment, and apparatuses (e.g., UEs, network nodes, etc.) in a wireless communications network, the wireless communications network including a network node in communication with the UE. In certain aspects, an instruction can be received from the network node to identify a post-processing metric from a received signal. The post-processing metric can be used for a mobility event.

Certain aspects of the implementations may also include performing post processing on the received signal to identify the post-processing metric.

Certain aspects of the implementations may also include generating a measurement report that includes the post-processing metric.

Certain aspects of the implementations may also include transmitting a measurement report to the network node, the measurement report including the post-processing metric.

Certain aspects of the implementations may also include receiving an instruction from the network node to perform a network mobility operation.

Certain aspects of the implementations may also include transmitting a signal to the network node that informs the network node that the UE is capable of performing post-processing on a signal.

Certain aspects of the disclosure pertain to systems, methods performed at a network node of a wireless communications network, and apparatuses of the wireless communications network. In some aspects, an instruction can be transmitted to a user equipment (UE) to use post-processing on a signal for triggering a mobility event. A post-processing metric can be received from the UE.

Certain aspects of the implementations may also include instructing the UE to perform a mobility event based on the post-processing metric.

In certain implementations, the post-processing metric is received in a measurement report from the UE.

Certain aspects of the implementations may also include receiving from the UE an indication that the UE can perform post-processing on a signal.

Certain aspects of the implementations may also include determining that the UE is not performing post-processing on a signal for network mobility, and instructing the UE to perform post-processing on the signal for network mobility.

Certain aspects of the implementations may also include analyzing the post-processing metric to determine whether the UE should perform network mobility.

Certain aspects of the implementations may also include transmitting an instruction to the UE to perform a network mobility operation.

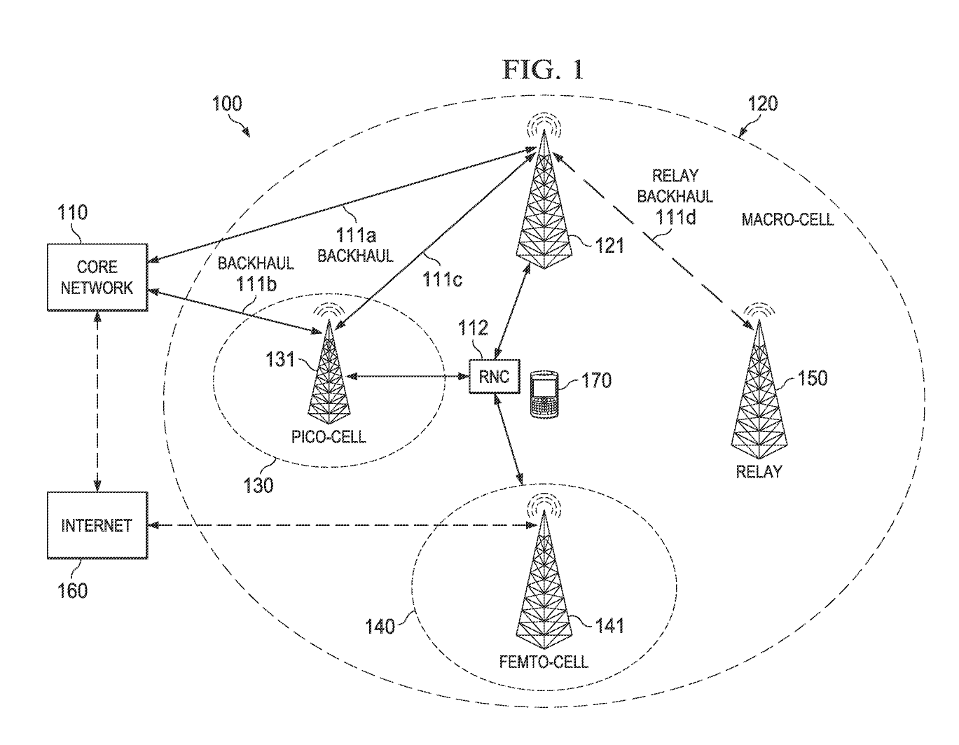

FIG. 1 is a schematic representation of an example heterogeneous wireless communication network 100. The term “heterogeneous wireless communication network” or “heterogeneous network” may also be referred to as a “HetNet.” The illustrated heterogeneous network 100 includes a core network 110 and a macro or overlay cell 120. The term “cell” or “wireless cell” generally refers to an area of coverage of wireless transmission by a network or network component, such as an access node. The core network 110 can be connected to the Internet 160. In the illustrated implementation, the macro cell 120 can include at least one base station. In this disclosure, the term “base station” is sometimes interchangeably used with a network node, an access node, or a network component. Two or more base stations may operate on the same radio frequency or on different radio frequencies. In this disclosure, the term “base station” is sometimes interchangeably used with the term “cell,” where the base station provides the coverage of wireless transmission of the cell. In some implementations, a Radio Network Controller (RNC) 112 can be connected to the various base stations (e.g., pico, macro, etc.). The RNC 112 can control handover decisions in UTRAN configured networks (while the eNB can do so in LTE and LTE-A configured networks).

The base station can be a macro eNB (also called an overlay access node) 121 connected to the core network 110 via a backhaul link 111a, including optical fiber or cable. The term “overlay access node” generally refers to a network element or component that at least partly serves to form a wireless cell. In one implementation in which the network 100 is an LTE network or LTE-Advanced network, the overlay access node 121 can be an evolved Universal Terrestrial Radio Access Network (E-UTRAN) node B (eNB). In another implementation in which the network 100 is a UTRA network, the overlay access node 121 can be a Universal Terrestrial Radio Access Network (UTRAN) node B (NB). In this disclosure, the terms “base station”, “eNB” and “NB” are sometimes used interchangeably. In yet another implementation in which the network is a WiMax network, the overlay access node 121 can be a WiMax base station. Note that this may also apply to GSM, CDMA or other networks. An eNB that forms an overlay access node of a macro cell can be generally referred to as a “macro eNB.” The term “eNB” may be interchangeably used with an “evolved node B.” The eNBs may cooperate to conduct a handover procedure for User Equipment (UE) in the network 100. To conduct the handover procedure, the eNBs may exchange control information via the backhaul link 111a, 111b, 111c or 111d.

The network 100 can also include one or more underlay cells, for example, a pico cell 130 and a femto cell 140. The underlay cells can have a coverage at least partially overlapping with the coverage of the macro cell 120. While the term “underlay cell” is described herein in the context of the long term evolution (LTE) standard, other wireless standards can also have components similar to underlay cells. The implementations described herein can be adapted for such standards without departing from the scope of this disclosure. Although FIG. 1 illustrates only one pico cell and only one femto cell, the network 100 can include more or less cells. The underlay cells 130, 140 have a smaller coverage than the macro (overlay) cell 120. For example, in a suburban environment, the macro cell 120 may have a coverage radius of 0.5 kilometer, while the underlay cells 130, 140 may have a coverage radius of 0.2 kilometer. Access nodes 131, 141 forming the underlay cells 130, 140 can use a lower transmission power than that of the overlay access node 121. The underlay cells 130, 140 may further include a range extension area used for increasing the coverage area for the cells having a smaller coverage.

The pico cell 130 can include a pico eNB 131 connected to the core network 110 via a backhaul link 111b and to the macro eNB 121 via a backhaul link 111c. The backhaul links 111b and 111c may include cable, fiber, wireless links, or others. In some implementations, the pico eNB 131 can have a transmission power that is, for example, about 30 dBm, which is about 16 dB lower than that of the macro eNB 121.

The femto cell 140 can include a femto eNB 141 connected to the core network 110 via the Internet 160 via a wired or wireless connection. The term “femto eNB” can also be referred to as a “home eNB (HeNB).” The femto cell 140 is a subscription based cell. Three access modes can be defined for HeNBs: closed access mode, hybrid access mode and open access mode. In closed access mode, HeNB provides services only to its associated closed subscription group (CSG) members. The term “closed subscription group (CSG)” can be interchangeably used with closed subscriber group. Hybrid access mode allows HeNB to provide services to its associated CSG members and to non-CSG members. In some implementations, the CSG members are prioritized to non-CSG members. An open access mode HeNB appears as a baseline eNB. The baseline eNB may be accessible by all UEs.

The network 100 can also include a relay node 150 which may wirelessly relay data and/or control information between the macro eNB 121 and user equipment 170. The macro eNB 121 and the relay node 150 can be connected to each other via a wireless backhaul link 111d. In such an instance, the macro eNB 121 can be referred to as a donor eNB. In some implementations, the relay node 150 can have a transmission power that is, for example, about 30 or 37 dBm, which is about 16 dB or 9 dB lower than that of the macro eNB 121.

The user equipment 170 can communicate wirelessly with any one of the overlay access nodes 121 or the underlay access nodes 131, 141, 150, depending on the location or the existence of subscription in the case of the femto cell 140. The term “underlay access node” generally refers to pico eNBs, femto eNBs, or relay nodes. The term “user equipment” (alternatively “UE”) can refer to various devices with telecommunications capabilities, such as mobile devices and network appliances. The UE 170 may switch from the coverage of one cell to another cell, for example, from the coverage of the pico cell 130 to the coverage of the macro cell 120, i.e., a pico-to-macro cell change, or from the coverage of a macro cell 120 to the coverage of the pico cell 130, i.e., a macro-to-pico cell change. A handover procedure may be conducted to ensure that the UE does not lose connection with the network while switching between cells.

Examples of user equipment include, but are not limited to, a mobile phone, a smart phone, a telephone, a television, a remote controller, a set-top box, a computer monitor, a computer (including a tablet computer such as BlackBerry® Playbook tablet, a desktop computer, a handheld or laptop computer, a netbook computer), a personal digital assistant (PDA), a microwave, a refrigerator, a stereo system, a cassette recorder or player, a DVD player or recorder, a CD player or recorder, a VCR, an MP3 player, a radio, a camcorder, a camera, a digital camera, a portable memory chip, a washer, a dryer, a washer/dryer, a copier, a facsimile machine, a scanner, a multi-functional peripheral device, a wrist watch, a clock, a game device, etc. The UE 170 may include a device and a removable memory module, such as a Universal Integrated Circuit Card (UICC) that includes a Subscriber Identity Module (SIM) application, a Universal Subscriber Identity Module (USIM) application, or a Removable User Identity Module (R-UIM) application. Alternatively, the UE 170 may include the device without such a module. The term “UE” can also refer to any hardware or software component that can terminate a communication session for a user. In addition, the terms “user equipment,” “UE,” “user equipment device,” “user agent,” “UA,” “user device,” and “mobile device” can be used synonymously herein.

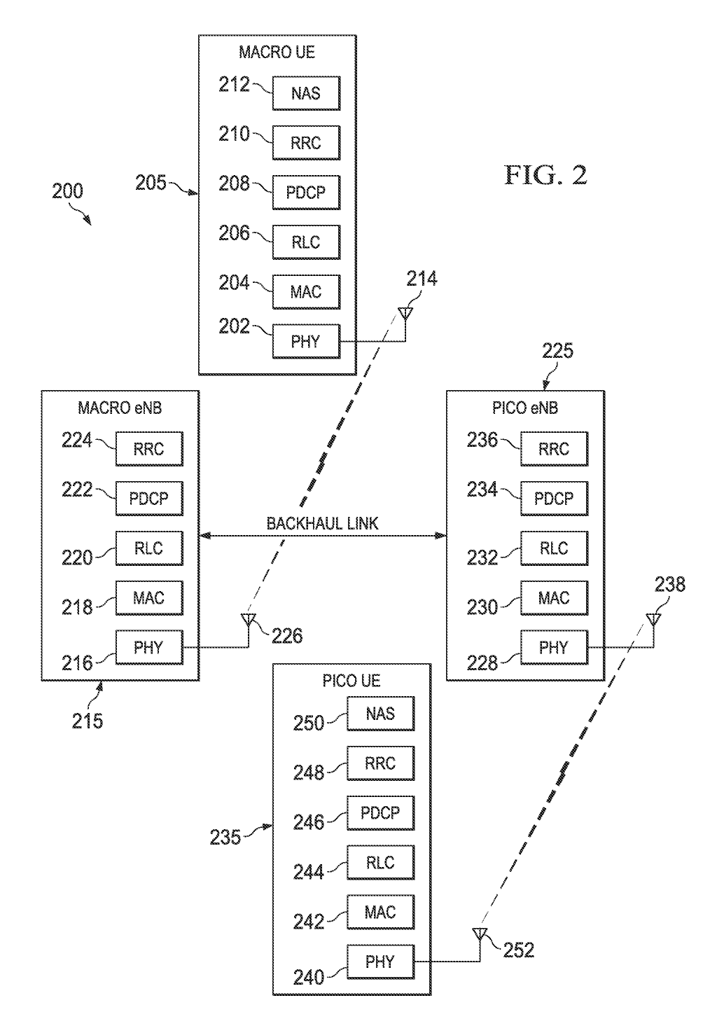

FIG. 2 is a schematic block diagram 200 illustrating various layers of access nodes and user equipment in an example wireless communication network. The illustrated system 200 includes a macro eNB 215, a pico eNB 225, a macro UE 205, and a pico UE 235. Here macro UE 205 and Pico UE 235 are UEs which are either actively communicating or camping on macro eNB 215 and pico eNB 225, respectively. The macro eNB 215 and the pico eNB 225 can be collectively referred to as a “network,” “network components,” “network elements,” “access nodes,” or “access devices.” FIG. 2 shows only these four devices (alternatively, referred to as “apparatuses” or “entities”) for illustrative purposes, and the system 200 can further include one or more of these devices without departing from the scope of this disclosure. The macro eNB 215 can communicate wirelessly with the macro UE 205. The pico eNB 225 can communicate wirelessly with the pico UE 235. The macro eNB 215 may communicate with the pico eNB 225 via a backhaul link, for example, an X2 backhaul link with a wired connection, a wireless connection, or a combination thereof. In some implementations, the macro eNB 215 and pico eNB 225 may exchange handover control information via the backhaul link.

Each of the devices 205, 215, 225 and 235 includes a protocol stack for communications with other devices via wireless or wired connection. The macro eNB 215 can include a physical (PHY) layer 216, a medium access control (MAC) layer 218, a radio link control (RLC) layer 220, a packet data convergence protocol (PDCP) layer 222, and a radio resource control (RRC) layer 224. In the case of user plane communications for data traffic, RRC layer may not be involved. The macro eNB 215 can also include one or more transmit and receive antennas 226 coupled to the PHY layer 216. In the illustrated implementation, a “PHY layer” can also be referred to as “layer 1 (L1).” A MAC layer can also be referred to as “layer 2 (L2).” The other layers (RLC layer, PDCP layer, RRC layer and above) can be collectively referred to as a “higher layer(s).”

Similarly, the pico eNB 225 includes a PHY layer 228, a MAC layer 230, a RLC layer 232, a PDCP layer 234, and an RRC layer 236. The pico eNB 225 can also include one or more antennas 238 coupled to the PHY layer 228.

The macro UE 205 can include a PHY layer 202, a MAC layer 204, a RLC layer 206, a PDCP layer 208, an RRC layer 210, and a non-access stratum (NAS) layer 212. The macro UE 205 can also include one or more transmit and receive antennas 214 coupled to the PHY layer 202. Similarly, the pico UE 235 can include a PHY layer 240, a MAC layer 242, a RLC layer 244, a PDCP layer 246, an RRC layer 248, and a NAS layer 250. The pico UE 235 can also include one or more transmit and receive antennas 252 coupled to the PHY layer 240.

Communications between the devices, such as between the macro eNB 215 and the macro UE 205, generally occur within the same protocol layer between the two devices. Thus, for example, communications from the RRC layer 224 at the macro eNB 215 travel through the PDCP layer 222, the RLC layer 220, the MAC layer 218, and the PHY layer 216, and are sent over the PHY layer 216 and the antenna 226 to the macro UE 205. When received at the antenna 214 of the macro UE 205, the communications travel through the PHY layer 202, the MAC layer 204, the RLC layer 206, the PDCP layer 208 to the RRC layer 210 of the macro UE 205. Such communications are generally done utilizing a communications sub-system and a processor, as described in more detail below.

In the implementations described in this disclosure, various steps and actions of the macro eNB, macro UE, pico eNB, and pico UE can be performed by one or more of the layers described above in connection with FIG. 2. For example, handover procedure for the macro UE 205 can be performed by one or more of the layers 202-212 of the macro UE 205. Handover procedure by the pico UE 235 can be performed by one or more of the layers 240-250 of the pico UE 235. Channel quality measurement may be performed by the PHY layer and MAC layer of the macro UE 205 and pico UE 235. For another example, handover of UE may be initiated by the RRC layer 224 of the macro eNB 215 and the RRC layer 236 of the pico eNB 225.

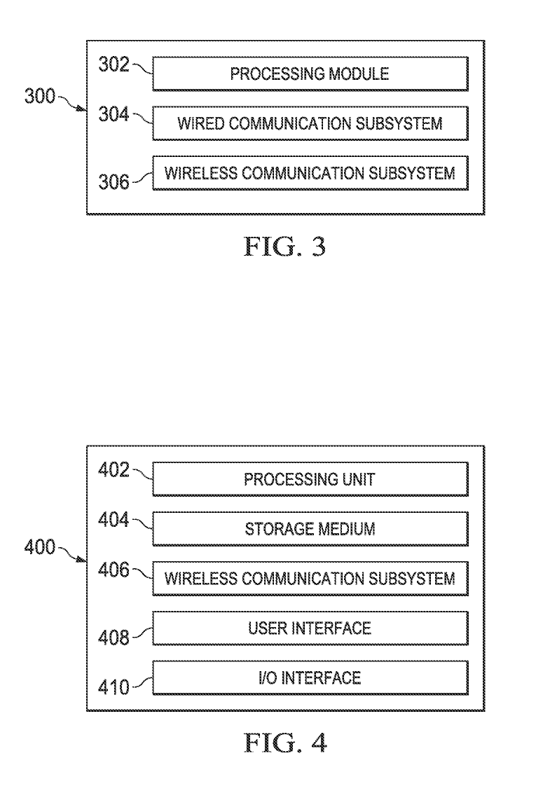

FIG. 3 is a schematic block diagram 300 illustrating an access node device or a network node device. The illustrated device 300 includes a processing module 302, a wired communication subsystem 304, and a wireless communication subsystem 306. The wireless communication subsystem 306 can receive data traffic and control traffic from the UE. In some implementations, the wireless communication subsystem 306 may include a receiver and a transmitter. The wired communication subsystem 304 can be configured to transmit and receive control information between other access node devices via backhaul connections. The processing module 302 can include one or more processing components (alternatively referred to as “processors” or “central processing units” (CPUs)) capable of executing instructions related to one or more of the processes, steps, or actions described above in connection with one or more of the implementations disclosed herein. The processing module 302 can also include other auxiliary components, such as random access memory (RAM), read only memory (ROM), secondary storage (for example, a hard disk drive or flash memory). The processing module 302 can form at least part of the layers described above in connection with FIG. 2. In some implementations, the processing module 302 may be configured to generate control information or respond to received information such as a measurement report transmitted from a UE. The processing module 302 may also be configured to make a RRM decision based at least in part on the information transmitted from the UE, such as cell selection/reselection information or the measurement report. The processing module 302 can execute certain instructions and commands to provide wireless or wired communication, using the wired communication subsystem 304 or a wireless communication subsystem 306. A skilled artisan will readily appreciate that various other components can also be included in the device 300.

FIG. 4 is a schematic block diagram 400 illustrating user equipment device. The illustrated device 400 includes a processing unit 402, a computer readable storage medium 404 (for example, ROM or flash memory), a wireless communication subsystem 406, a user interface 408, and an I/O interface 410.

Similar to the processing module 302 of FIG. 3, the processing unit 402 can include one or more processing components (alternatively referred to as “processors” or “central processing units” (CPUs)) configured to execute instructions related to one or more of the processes, steps, or actions described above in connection with one or more of the implementations disclosed herein. The processing module 402 can form at least part of the layers described above in connection with FIG. 2. In some implementations, the processing module 402 may be configured to generate control information, such as a measurement report, or respond to received information, such as control information from a network node. The processing module 402 may also be configured to make a RRM decision such as cell selection/reselection information or triggering a measurement report. The processing unit 402 can also include other auxiliary components, such as random access memory (RAM) and read only memory (ROM). The computer readable storage medium 404 can store an operating system (OS) of the device 400 and various other computer executable software programs for performing one or more of the processes, steps, or actions described above.

The wireless communication subsystem 406 may be configured to provide wireless communication for data and/or control information provided by the processing unit 402. The wireless communication subsystem 406 can include, for example, one or more antennas, a receiver, a transmitter, a local oscillator, a mixer, and a digital signal processing (DSP) unit. In some implementations, the subsystem 406 can support multiple input multiple output (MIMO) transmissions.

The user interface 408 can include, for example, one or more of a screen or touch screen (for example, a liquid crystal display (LCD), a light emitting display (LED), an organic light emitting display (OLED), a micro-electromechanical system (MEMS) display), a keyboard or keypad, a trackball, a speaker, and a microphone. The I/O interface 410 can include, for example, a universal serial bus (USB) interface. A skilled artisan will readily appreciate that various other components can also be included in the device 400.

In some implementations, the receivers in the wireless communication subsystems 306 and 406 can be an advance receiver or a baseline receiver. Two receivers can be implemented with identical, similar, or different receiver processing algorithms.

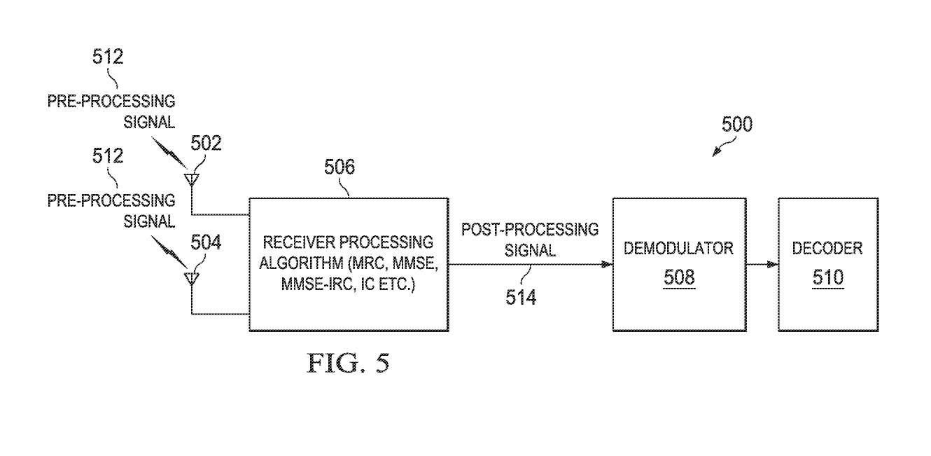

FIG. 5 is a block diagram illustrating an example receiver 500 of a wireless communication subsystem (e.g., 306 or 406). In the illustrated example, the receiver 500 includes two antennas 502 and 504, a receiver processing module 506, a demodulator 508, and a decoder 510. Wireless signals 512 can be received at the antenna 502 or 504. The signals 512 received by antennas 502 and 504 can be identical, similar, or different depending at least in part on a radio environment between the transmit antenna and the receive antenna. In some implementations, a plurality of signals can be received by each antenna of the receiver. The received signals 512 can be collectively referred to as a pre-processing signal because it has not been processed by the receiver processing module 506 yet.

Based at least in part on the signal 512 received at the antenna connector, a variety of metrics can be measured and hence be referred to as pre-processing metrics. For example, a pre-processing metric can be a pre-processing signal quality or a representation of the pre-processing signal quality. For a wireless communication subsystem in UE (e.g. 406), in case of LTE some example pre-processing signal qualities include RSRP (Reference Signal Received Power) and RSRQ (Reference Signal Received Quality). In case of UTRAN, some example pre-processing signal qualities include Common Pilot Channel (CPICH) RSCP (Received Signal Code Power), pilot Ec/N0, or path-loss. The above example pre-processing metrics may be average signal quality measured at the output of one or both of the antenna ports of the UE. If the UE has multiple receiving antennas, the measurements at one or both of the receiving antennas may be collected. In LTE, RSRP and RSRQ are measured based on cell-specific reference signals (CRS). RSRP measures the average received power over the resource elements that carry cell-specific reference signals within certain frequency bandwidth. RSRQ can indicate the quality of the received reference signal and can be expressed of ratio of two quantities. The numerator of RSRQ is the average received power per CRS resource element based on the CRS of antenna port 0 (the CRS of antenna port 1 could also be used if it can be reliably detected). The denominator of RSRQ is the average total received power per OFDM (Orthogonal Frequency Division Multiplexing) symbol over one resource block from all sources, including co-channel serving and non-serving cells, adjacent channel interference and thermal noise. The reference point of RSRP and RSRQ is the antenna connector of the UE and hence RSRP and RSRQ can be regarded as pre-processing metrics. RSRP and RSRQ can be used in both RRC idle and RRC connected modes. As a specific example, RSRP and RSRQ can be used in the procedure of cell selection and cell reselection in RRC idle mode in LTE. RSRP and RSRQ are also used in the RRC connected mode for the handover procedure.

The signal 512 is then input into the receiver processing module 506 for processing. The output signal of the receiver processing module 506 can be referred to as a post-processing signal or a processed signal 514. Subsequently, the post-processing signal is input into the demodulator 508 and the decoder 510.

Based at least in part on the post-processing signal 514, a variety of metrics can be measured and thus be referred to as post-processing metrics. For example, a post-processing metric can be a post-processing signal quality or a representation of the post-processing signal quality. The post-processing signal quality can reflect the effective signal quality for data demodulation and decoding. An example post-processing signal quality is post-processing Signal to Interference plus Noise Ratio (SINR), which can be defined as the SINR of the post-processing signal 514. In general a post processing signal quality is representative of the receiver performance, such as, the packet error rate. In general, the receiver processing at the UE depends on the transmission scheme set for a communication link. The number of available receive antennas used by a UE at a given time to decode a signal may be implementation dependent.

All or part of the receiver processing module 506 may be implemented by a processing module such as 302 or 402 of the network node and the UE, respectively. Or all or part of the receiver processing module 506 may be implemented by some other processing unit as appropriate.

The receiver processing module 506 may perform one or more receiver processing algorithms. There are a number of advanced receiver processing algorithms that enable the receiver 500 with different capability to suppress/cancel interference. While some example advanced/enhanced receivers are discussed as below, various other receivers with similar or different implementations can also be included without departing from the scope of this disclosure.

An MRC (Maximum Ratio Combining) receiver can include a receiver processing module 506 which performs an MRC algorithm. The MRC receiver can proportionally combine multiple received signals by having each signal branch multiplied by a weight factor that is proportional to the signal amplitude. The MRC receiver may not consider the interference when combining the received signals. UTRA UE type 1 receiver is an example of the MRC receiver.

An MMSE (Minimum Mean Square Error) receiver can include a receiver processing module 506 which performs an MMSE algorithm. The MMSE receiver can estimate the interference statistics and assume the interference powers are the same at receiving antennas. The MMSE receiver combines the signals such that the post-processing SINR is maximized assuming the same interference power at the antennas. UTRA UE type 2 and 3 receivers are examples of the MMSE receiver.

An MMSE-IRC (MMSE-Interference Rejection Combining) receiver can include a receiver processing module 506 which performs an MMSE-IRC algorithm. The MMSE-IRC receiver can better estimate the interference statistics than the MMSE receiver, for example, by assuming the interference powers at receiving antennas are different. The MMSE-IRC receiver can better combine the received signals to suppress interference. UTRA UE type 3i receiver is an example of the MMSE-IRC receiver.

An IC (Interference Cancellation) receiver can include a receiver processing module 506 which performs an IC algorithm. The IC receiver can estimate an interfering signal and can cancel/subtract the interference. The IC receiver has a better capability to suppress interference at the cost of additional processing, compared with the MMSE-IRC, MMSE, and MRC receivers. For example, an IC receiver could be a successive interference cancellation (SIC) receiver.

A Rake receiver can include a receiver processing module 506 which performs a Rake algorithm. The Rake receiver can counter the effects of multipath fading, for example, by using several “sub-receivers” called fingers, that is, several correlators each assigned to a different multipath component. Each finger may independently decode a single multipath component. Contributions of all fingers are combined. The Rake receiver can improve signal-to-noise ratio (or Eb/N0) in a multipath environment.

With different receiver implementations, two receivers may experience significantly different post-processing signal qualities for a given received signal 512. In some instances, the post-processing SINR variability between MRC and IC receiver could be easily more than 5 dB (for example, if the UE can completely cancel the dominant interferer). The difference here may significantly impact the mobility events.

Incorporating post-processing metrics into RRM (Radio Resource Management) decision making can help account for the difference in receivers' receiving abilities/performances and may better capture the effective signal quality for demodulation and decoding. In this way, some RRM decisions, such as triggering a mobility event, can be made at or close to an optimum point.

In a wireless communication network, mobility can typically be classified into two types: UE-controlled mobility and Network-controlled mobility. While the following disclosure is primarily described in the context of LTE/LTE-A and UTRAN networks, the implementations described herein can be adapted for other wireless networks without departing from the scope of this disclosure, such as GSM/EDGE/WiMAx networks. In fact, various aspects of the disclosure are useful in any wireless system (e.g., cellular networks, wireless local area networks, ad hoc connections, etc.) that can benefit from a channel/signal quality feedback.

A wireless device can make transitions between states, such as Radio Resource Control (RRC) states. For example, in the LTE system, two RRC states exist, RRC_CONNECTED and RRC_IDLE (also known as RRC connected mode and RRC idle mode). In an RRC connected mode, dedicated radio resources are established to enable the transfer of user data through a radio access network and onwards to the core network. In the RRC idle mode, dedicated radio resources are not established and user data is not transferred. In some implementations, in RRC idle mode a UE monitors a paging channel and acquires system information. Further, the UE may perform cell selection/reselection according to the configurations. The detailed LTE idle mode procedure is defined in the TS 36.304. The detailed UTRAN idle mode procedure is defined in the TS 25.304.

In UTRAN, the UE-controlled mobility refers to cell selection/reselection in Idle Mode and the lower states of RRC Connected Mode. In LTE/LTE-A, the UE-controlled mobility refers to cell selection/reselection in RRC idle Mode. The decision to camp on a given cell can be made by the UE, within the constraints of network-signaled parameters.

Network-controlled mobility refers to handover in RRC connected state. The handover decision can be made by the network, for example, by the Radio Network Controller (RNC) in UTRAN and eNB in LTE/LTE-A.

In RRC connected mode, the UE can be configured to perform measurement reporting to support the mobility. In LTE, the following event-triggered reporting criteria are specified:
Event A1: Serving cell becomes better than threshold
Event A2: Serving cell becomes worse than threshold
Event A3: Neighbor cell becomes offset better than the serving PCell (primary cell)
Event A4: Neighbor cell becomes better than threshold
Event A5: Serving PCell becomes worse than threshold1 and neighbor cell becomes better than threshold2
Event A6: Neighbor cell becomes offset better than SCell (secondary cell)
Event B1: Inter RAT (radio access technology) neighbor cell becomes better than threshold
Event B2: Serving PCell becomes worse than threshold1 and inter RAT neighbor cell becomes better than threshold2

In the case of UTRAN, the following event-triggered measurement criteria are specified in 3GPP TS25.331 for intra-frequency handovers:
Event 1A: A Primary CPICH (Common Pilot Channel) enters the reporting range
Event 1B: A Primary CPICH leaves the reporting range
Event 1C: A non-active Primary CPICH becomes better than an active Primary CPICH
Event 1D: Change of best cell
Event 1E: A Primary CPICH becomes better than an absolute threshold
Event 1F: A Primary CPICH becomes worse than an absolute threshold
Event 1J: A non-active E-DCH (Enhanced Dedicated Channel) but active DCH Primary CPICH becomes better than an active E-DCH Primary CPICH

A further set of UTRAN measurement criteria for inter-frequency and inter-RAT handovers exists in 3GPP TS25.331.

The UTRAN cell selection and reselection criteria are specified in 3GPP TS 25.304 and are based on Primary CPICH RSCP and Primary CPICH Ec/N0.

The post-processing signal quality or a representation of the post-processing signal quality can be used to make RRM (radio resource management) decisions such as mobility-related decisions or, in idle mode, cell selection/reselection decisions. In some implementations, the post-processing signal quality can be employed to assist one or more intra-frequency mobility, inter-frequency mobility, or inter-RAT (Radio Access Technology) mobility. As one example, in case of the handover in RRC connected state, post-processing signal quality can be used as a trigger quantity and/or report quantity for measurement reports. In RRC idle state, the UE can decide which cell to camp on or whether to reselect a cell based on the post-processing signal quality.

The post-processing signal quality can capture a receiver's ability to receive and process signals. For one example, different UEs experiencing identical radio conditions may report identical (or similar) pre-processing measurements but experience significantly different post-processing signal quality. This can happen because pre-processing measurements are functionally specified and, to a degree, implementation independent whereas post-processing measurements are strongly dependent on UE receiver implementations (e.g. baseline, advanced). The post-processing signal quality can reflect the receiver's capability in receiving and processing signal. For another example, the post-processing measurements can capture sufficient detail regarding the nature of the received signal as well as the interfering signals that determines the post-processing metric. For example, even if identical UEs in two different locations report the same pre-processing metrics, their post-processing metrics could be significantly different due to, e.g., experiencing different multipath or interfering signals coming from different directions. The post-processing signal quality can be a more accurate indicator of the effective signal that determines demodulation and decoding performances.

The post-processing metrics may be beneficial to any wireless communication network that may involve one or more of signal/channel quality feedback, a mobility event, or UEs with different receiving abilities/performances. As an example, the following description is primarily focused on HetNet scenarios, where one or more mobility events can be triggered based at least in part on post-processing signal quality metrics.

A deployment of low power cells such as pico cells in a HetNet can help offload traffic from the macro cells. To offload more traffic from macro cells, low power cells such as pico cells may employ range extension (RE) such that the UE can still communicate with a pico cell even though the signal strength from the pico cell is weaker than that of the macro cell. For HetNet deployments of macro cell and low power cells on the same frequency, interference coordination plays an important role. In 3GPP LTE Rel-10, enhanced Inter-Cell Interference Coordination (eICIC) is adopted to solve interference issues. There are two main deployment scenarios where eICIC is used.

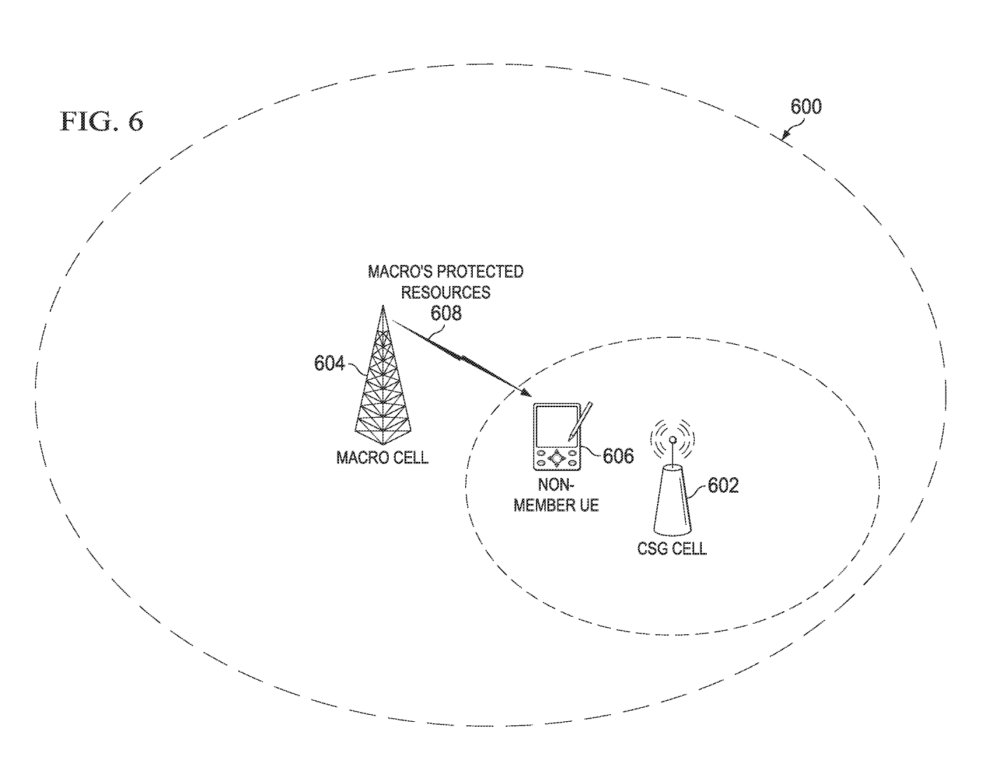

FIG. 6 is a schematic representation 600 of an example deployment where eICIC may be used. As shown in FIG. 6, a femto cell 602 is situated within the coverage of a macro cell 604. The femto cell 602 may be a CSG (Close Subscriber Group) cell. A UE 606 may be a non-member UE of the CSG cell 602. When the non-CSG member UE 606 is in the coverage area of the CSG cell 602, it is not allowed to access to the CSG cell 602. The non-CSG member UE 602 needs to be served by the macro cell 604 under the strong interference from the CSG cell 602. To allow such a non-member UE 606 to remain served by the macro cell 604, Almost Blank Subframes (ABS) can be configured on the CSG cell 602. The non-CSG member UE 606 can communicate with the macro cell 604 during the ABS. The CSG cell 602 utilizes ABS to protect the corresponding macro cell's subframes 608 from the interference. The non-CSG member UE 606 may be signalled to utilize the protected resources for radio resource management (RRM), radio link monitoring (RLM) and Channel State Information (CSI) measurements for the serving macro cell 604, allowing the UE 506 to continue to be served by the macro cell 604 under otherwise strong interference from the CSG cell 602.

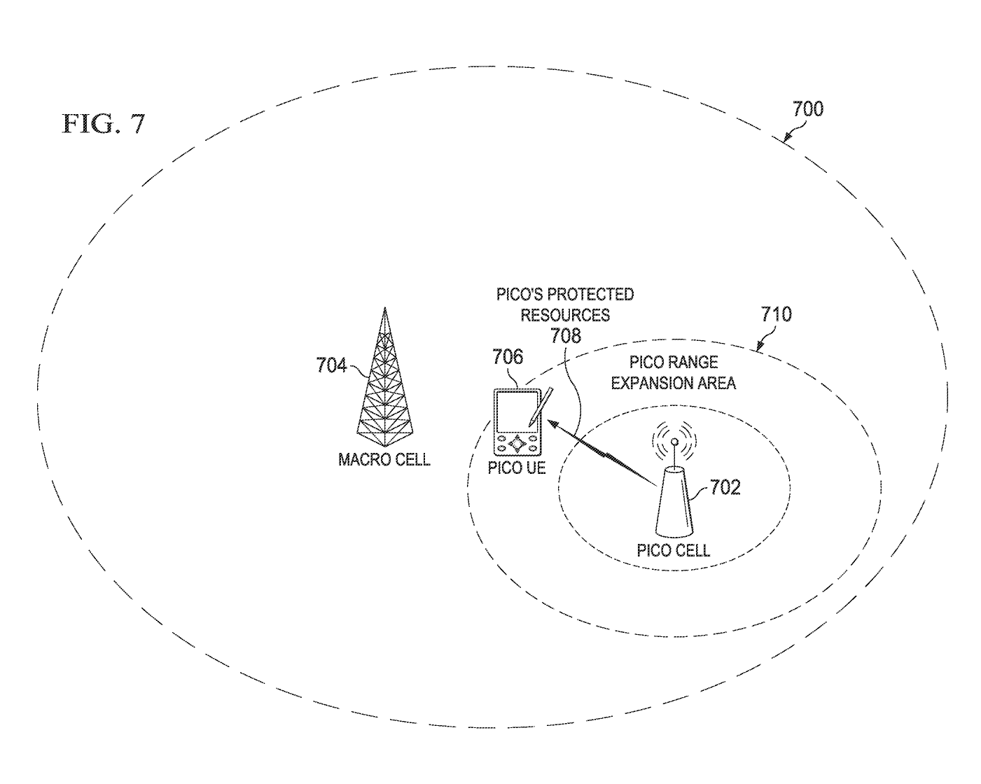

FIG. 7 is schematic presentation 700 of another example scenario where eICIC may be used. A pico cell 702 is situated in the coverage range of a macro cell 704. In this macro-pico case, to offload more traffic from the macro cell 704, range extension can be used in the pico cell 702. Pico UEs, such as UE 706, that are in the range extension area 710 need to be served by the pico cell 710 under the strong interference from the macro cell 704. To allow such UEs to remain served by the pico cell 702, ABS can be configured on the macro cell 704. The pico UEs in the range extension area can communicate with the pico cell 702 during the ABS. The macro cell 704 utilizes ABS to protect the corresponding pico cell's subframes 708 from the interference. The pico UE 706 in range extension area 710 can use the protected resources 708 during macro cell ABS for radio resource management (RRM), radio link monitoring (RLM) and Channel state information (CSI) measurements for the serving pico cell 702 and possible neighboring pico cell(s) (not shown).

For the time domain eICIC, subframe utilization across different cells is coordinated in time through backhaul signaling or OAM (Operations, Administration, and Maintenance) configuration of so called Almost Blank Subframe patterns. The Almost Blank Subframes (ABSs) in an aggressor cell (e.g. the CSG cell 602 in FIG. 6 or the macro cell 704 in FIG. 7) can be used to protect resources in subframes in the victim cell (e.g. the macro cell 604 in FIG. 6 or the pico cell 702 in FIG. 7) receiving strong inter-cell interference from the aggressor cell. Almost blank subframes are subframes with reduced transmit power (including no transmission) and/or reduced activity on some physical channels. The eNB can ensure backwards compatibility towards UEs by transmitting necessary control channels and physical signals as well as System Information. Patterns based on ABSs can be signaled to the UE to restrict the UE measurement to specific subframes called time domain measurement resource restrictions. There are different patterns depending on the type of measured cell (serving or neighbor cell) and measurement type (e.g., RRM, RLM).

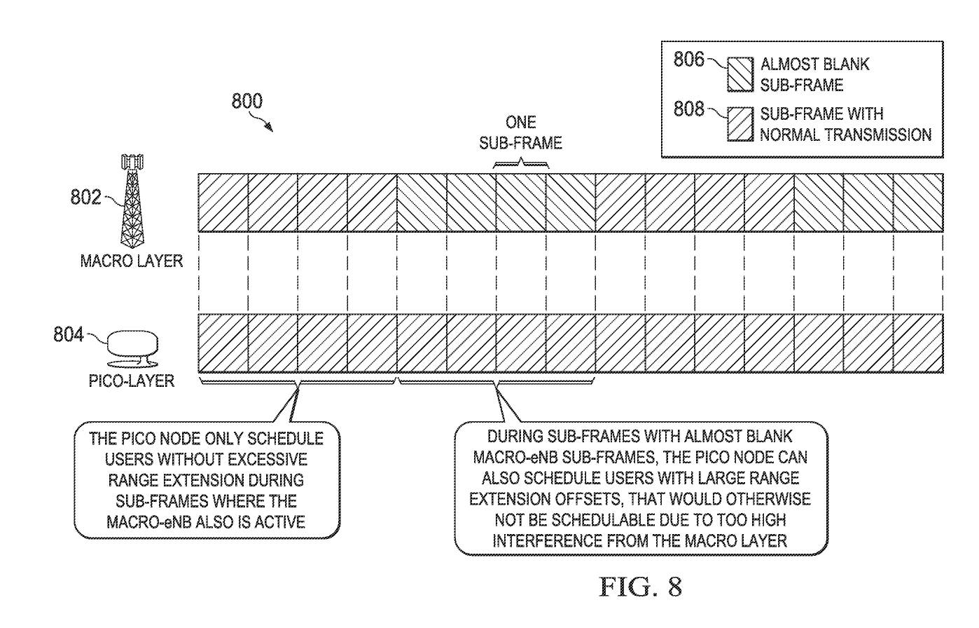

FIG. 8 is a schematic presentation 800 of an example of the almost blank subframe (ABS) patterns. In this example, the macro base station 802 (the aggressor) can configure and transfer the ABS patterns 806 to the pico base station 804 (victim). The macro base station 802 may not schedule data transmissions in ABS subframes 806 to protect the UEs served by the pico base station 804 in the edge of the pico cell. The pico base station 804 may schedule transmissions to and from the UEs in the cell center regardless of the ABS patterns 806 because the macro interference is sufficiently low and/or the pico signal is sufficiently strong. Meanwhile the pico base station 804 may schedule transmissions to and from the UEs in the edge of the cell only in ABS 806.

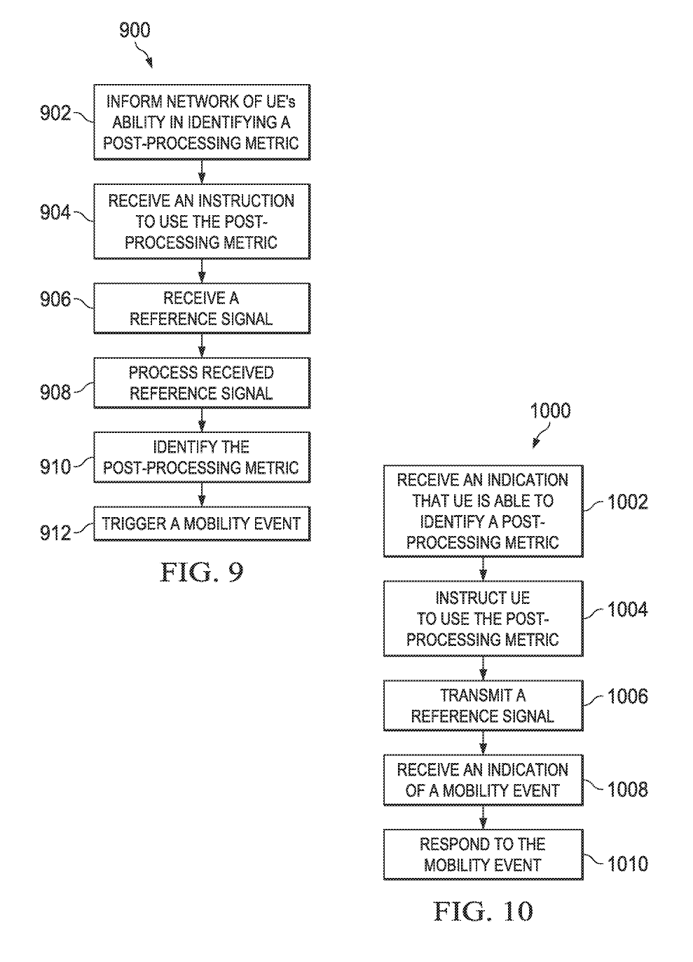

FIG. 9 is a flow chart illustrating an example method 900 that may be performed by a UE of a wireless communication network. The example method 900 relates to triggering a mobility event. The mobility event can include one or more of a cell selection or reselection event, a measurement report triggering event, or any other appropriate RRM related event.

At 902, the UE may inform the network about the UE's capability. For example, the UE may inform the network about whether the UE is capable of identifying a post-processing metric. In some implementations, the UE can inform the network of one or more of the UE's receiver type, the receiving algorithm that the UE may perform, the type of post-processing metric that UE may use, or any other appropriate information. Such information can be sent to the network, for example, in an RRC message.

At 904, the UE may receive an indication from the network to use a post-processing metric to trigger a mobility event. For example, the UE may receive a configuration message or an RRC message from the network. The message may indicate the UE to provide the post-processing metric to the network, such as in a measurement report. The UE may also receive a threshold value related to a mobility event so that the UE can determine whether to trigger the mobility event based at least in part on the threshold value and the post-processing metric. In another alternative, a new measurement entity may be defined in the standards to represent post processing metric. In this case, the network may configure the UE to measure the post processing metric similar as RSRP/RSRQ measurement.

The steps 902 and 904 may be optional, or one or both of them may be performed during initial access process of the UE, during RRC connected mode, or any other time as necessary.

At 906, the UE may receive a signal, such as a reference signal. A reference signal can include one or more of a pilot, a training sequence, a control signal, a traffic signal, or any other signal as appropriate. As a specific example, the reference signal can be one or more of CRS (Cell-specific Reference Signal) or CSI-RS (Channel State Information-Reference Signal) (e.g., zero power CSI-RS as interference measurement resource or non-zero power CSI-RS). Referring to illustrated example in FIG. 5, the reference signal from a cell can be part of the pre-processing signal 512. The pre-processing signal 512 could also include interfering signals from neighboring cells received at the same time as the reference signal. In the case of HetNet, the reference signal may be received during Almost Blank Subframes (ABS) or Multimedia Broadcast multicast service Single Frequency Network (MBSFN) subframes.

At 908, the UE can process the received signal based at least in part on a receiver processing algorithm. The received signal includes the reference signal as well as the interfering signals from neighboring cells. Referring to illustrated example in FIG. 5, the received reference signal can be part of the pre-processing signal 512. For example, the UE may have a receiver processing module (such as 506 in FIG. 5) to process the received reference signal. The receiver processing algorithm may include one or more of an MRC algorithm, an MMSE algorithm, an MMSE-IRC algorithm, an IC algorithm, a Rake algorithm, or any other appropriate algorithm. In some implementations, the receiver processing algorithm may need to fulfill the requirements corresponding to at least one of enhanced receiver types 1, 2, 3, 3i in UTRAN.

At 910, the UE may identify a post-processing metric based at least in part on the received reference signal. In some implementations, the post-processing metric can be a signal quality measurement or a representation of the signal quality measurement. The post-processing metric can include one or more of a measure of traffic channel spectral efficiency, a measure of control channel demodulation quality, a measure of reference signal or data channel Signal to Interference plus Noise Ratio (SINR), a Channel Quality Indicator (CQI), or any other appropriate metric. In some implementations, a post-processing metric based on the received reference signal may be measured based at least in part on one or more of an estimated channel response between a transmit and receive antenna pair, interference statistics, a block error rate, and a transmission mode.

At 912, the UE may trigger a mobility event based at least in part on the post-processing metric. In some implementations, such as in RRC idle state or UTRA CELL_PCH or CELL_FACH state, the UE may perform a cell selection/reselection procedure based at least in part on the post-processing metric. In this case, in addition to identifying the post-processing metric of the UE's serving cell, the UE may also identify a post-processing metric for each of one or more of neighboring cells. The UE may then compare these identified metrics, possibly with a threshold, and determine a target cell to camp on. Then the UE may send some information to the network indicating the cell selection/reselection decision. The UE may later coordinate with the network to change a new cell or stay with the current serving cell. In some other implementations, such as in RRC connected state, the UE may trigger a measurement report. There may be a number of measurement report triggering events defined in the network. The UE may be configured by the network for one or more measurement report triggering events based at least in part on one or more post-processing metrics. In this case, the UE may identify a measurement report trigger event based at least in part on the post-processing metric, generate a measurement report and transmit the measurement report to the network. As one example, the measurement report trigger event is a Type I event (such as A1 or A2 event in LTE), wherein the Type I event is triggered when a signal quality of a serving cell of the UE becomes greater than a threshold in case of A1 event or when a signal quality of a serving cell of the UE becomes worse than a threshold in case of A2 event. As another example, the measurement report trigger event is a Type II event (such as A3, A4, A5, A6, B1 or B2 event in LTE), wherein the Type II event is triggered when a signal quality of a neighboring cell becomes better than a serving primary cell (PCell) of the UE by a threshold in case of A3 event, when a signal quality of a neighboring cell of the UE becomes better than a threshold in case of A4 event, when a signal quality of a serving PCell of the UE becomes worse than a threshold and a signal quality of a neighboring cell becomes better than another threshold in case of A5 event, when a signal quality of a neighboring cell becomes better than a serving secondary cell (SCell) by a threshold in case of A6 event, when a signal quality of an inter-RAT neighboring cell of the UE becomes better than a threshold in case of B1 event, or when a signal quality of a serving PCell of the UE becomes worse than a threshold and a signal quality of an inter-RAT neighboring cell becomes better than another threshold in case of B2 event. In another example, the measurement report trigger event is one of the UTRAN events 1A, 1B, 1C, 1D, 1E, 1F, 1G, 1H, 1I, 1J, 2a, 2b, 2c, 2d, 2e, 2f, 3a, 3b, 3c, 3d. In some implementations, the UE may further receive control information (such as a one-bit indicator) instructing the UE to include one or more neighboring cell measurements into the measurement report triggered by certain measurement report triggering events (such as the Type I event). The UE may follow the instruction; include the one or more neighboring cell measurements into the measurement report; and transmit the measurement report to the network node. In some other implementations, the UE may include the post-processing metric in the measurement report to the network. In yet some other implementations, the UE may be instructed to use post processing metric for certain measurement entities while using pre-processing metric such as RSRP/RSRQ for other measurement entities. Different threshold values could be configured.

FIG. 10 is a flow chart illustrating an example method 1000 may be performed by a network node of a wireless communication network. The example method 1000 relates to triggering a mobility event. The network node can be a base station or a mobility control unit of the wireless communication network. The network node can associated with a macro cell, a pico cell, a femto cell, or any other type of cell or network. As a specific example, the network node may be an eNB in the case of LTE/LET-A, or an RNC in the case of UTRAN.

At 1002, the network node may receive an indication from the UE about whether the UE is capable of identifying a post-processing metric. In some implementations, the network node may receive information about one or more of the UE's receiver type, the receiving algorithm that the UE may perform, the type of post-processing metric that UE may use, or any other appropriate information. Such information can be received from the UE, for example, in an RRC message.

At 1004, the network node may transmit to the UE an indication instructing the UE to use a post-processing metric to trigger a mobility event. The mobility event can include one or more of a cell selection or reselection event, a measurement report triggering event, or any other appropriate RRM related event. In some implementation, the network node may include an indication in the measurement configuration to instruct a UE in RRC connected mode to use a post-processing metric to trigger a measurement report. In some implementations, the network node may include an indication in a System Information Block (SIB) to instruct an idle UE to use a post-processing metric to trigger a cell selection or reselection event. In some other implementations, the network node may include an indication in the RRCConnectionRelease message to instruct an idle UE to use a post-processing metric to trigger a cell selection or reselection event.

The steps 1002 and 1004 may be optional, or one or both of them may be performed during initial access process of the UE, during RRC connected mode, or any time as necessary.

At 1006, the network node may transmit a reference signal(s) to the UE. The reference signal can include one or more of a pilot, a training sequence, a control signal, a traffic signal, or any other signal as appropriate. As a specific example, the reference signal can be CRS (Cell-specific Reference Signals) or CSI-RS (Channel State Information-Reference Signals) (e.g., zero power CSI-RS as interference measurement resource or non-zero power CSI-RS). In the case of HetNet, the reference signal may be transmitted during Almost Blank Subframes (ABS) or Multimedia Broadcast multicast service Single Frequency Network (MBSFN) subframes.

At 1008, the network node may receive from the UE an indication of a mobility event. The mobility event may be triggered based at least in part on the post-processing metric. In some implementations, the network node may receive a measurement report triggered by a measurement report trigger event. As one example, the measurement report trigger event is a Type I event (such as A1 or A2 event in LTE), wherein the Type I event is triggered when a signal quality of a serving cell of the UE becomes better than a threshold in case of A1 event or when a signal quality of a serving cell of the UE becomes worse than a threshold in case of A2 event. As another example, the measurement report trigger event is a Type II event (such as A3, A4, A5, A6, B1, or B2 event in LTE), wherein the Type II event is triggered when a signal quality of a neighboring cell becomes better than a serving primary cell (PCell) of the UE by a threshold in case of A3 event, when a signal quality of a neighboring cell of the UE becomes better than a threshold in case of A4 event, when a signal quality of a serving PCell of the UE becomes worse than a threshold and a signal quality of a neighboring cell becomes better than another threshold in case of A5 event, when a signal quality of a neighboring cell becomes better than a serving secondary cell (SCell) by a threshold in case of A6 event, when a signal quality of an inter-RAT neighboring cell of the UE becomes better than a threshold in case of B1 event, or when a signal quality of a serving PCell of the UE becomes worse than a threshold and a signal quality of an inter-RAT neighboring cell becomes better than another threshold in case of B2 event. In some implementations, the network node may further send control information (such as a one-bit indicator) instructing the UE to include one or more neighboring cell measurements into the measurement report triggered by certain measurement report triggering event (such as the Type I event). In some other implementations, the network node may receive measurement reports from the UE which includes the post-processing metric.

In some implementations, the network node may receive from the UE a measurement report that includes the post-processing metric, as well as other measurement results. The serving cell and the neighboring cells can receive this measurement report, in accordance with measurement report controls. Mobility events can be triggered based on the results of the measurements, which can be included in the measurement report.

At 1010, the network node may respond to the indication of the mobility event. In some implementations, the network node can make RRM decisions based at least in part on the measurement report received from the UE. As an example, the network node may decide whether to handover the UE to a target cell based at least in part on the measurement report triggered by the mobility event (such as the Type I or Type II event).

The example methods 900 and 1000 shown in FIG. 9 and FIG. 10, respectively, can be modified or reconfigured to include additional, fewer, or different operations, which can be performed in the order shown or in a different order. In some instances, one or more of the operations can be repeated or iterated, for example, until a terminating condition is reached. In some implementations, one or more of the individual operations shown in FIGS. 9-10 can be executed as multiple separate operations, or one or more subsets of the operations shown in FIGS. 9-10 can be combined and executed as a single operation.

In the following, some specific examples are provided in the context of LTE/LTE-A and UTRAN. In particular, RRM (radio resource management) decisions such as handover or cell selection/reselection based at least in part on one or more of a pre-processing signal quality, a post-processing signal quality, or a representation of a post-processing signal quality are discussed. A skilled artisan will readily appreciate that various other RRM decisions in various other wireless communication networks can also be implemented with teachings of this disclosure.

In some implementations, if range extension (RE) is enabled on the pico cell for traffic offloading (e.g., as illustrated in FIG. 7), typically the UE (e.g., 706) can be served by the pico cell (e.g., 702) even when the signal strength from the pico cell (e.g., 702) is lower than that from the macro cell (e.g., 704). For example, if the RE bias value is X dB (where X>0), when the UE 706 moves from the pico cell 702 towards the macro cell 704, the UE 706 may not be handed over to the macro cell 704 until the following condition meets: RSRP of the neighboring macro cell 704>RSRP of the serving pico cell 702+X dB (assume A3 offset to be zero).

ABS can be enabled on the macro cell to create interference-free or interference-reduced subframes so that the UEs in range extension area can be served by the pico cell. But depending on the pico cell location and the ABS patterns of the macro cells, the pico UE in range extension area may not always see sufficient SINRs. In some scenarios, if macro cells use the same ABS patterns, then during the ABS the pico UE may not see any interference from these macro cells. In this case the macro interference is reduced significantly and the pico UE in range extension area could see sufficient SINRs for reliable communications. In some other cases, if the macro cells do not have synchronized ABS patterns and the pico UE is only immune to the interference from the macro cell that the pico cell belongs to (for example, the pico cell is in the coverage of the macro cell), in this case the reduced macro interference may not be low enough to keep a good SINR level in the range extension area. When the ABS patterns of neighboring macro cells are not synchronized, the insufficient SINR levels in the pico range extension area could cause radio link failure (RLF) or cause pico-to-macro handover failure (HOF) because the handover (HO) command from the pico cell cannot be reliably delivered to the UE.

Similarly, in some implementations, when the UE (e.g., 706) is moving from the macro cell (e.g., 704) into a RE enabled pico cell (e.g., 702), typically the UE may not be handed over to the pico cell until the following condition is met: (RSRP of the neighboring pico cell)>(RSRP of the serving macro cell−X dB) (assuming that A3 offset to be zero and RE bias value to be X dB). In some scenarios, if the neighboring macro cells do not have synchronized ABS patterns and the pico UE is only immune to the interference from the macro cell that the pico cell belongs to, the insufficient SINR levels in the pico range extension area could cause macro-to-pico handover failure due to a failed random access procedure to the target pico cell.

In some implementations, such as the situations illustrated above, it may not be necessary to force every UE in the range extension area to connect to the pico cell. For example, a pico UE in range extension area may hand over to the macro cell if the received SINR from the pico cell transmission is too low. Similarly, a macro UE in the pico range extension area may not hand over to the pico cell unless the received SINR from the pico cell transmission is sufficiently high. Mechanisms are desirable to let the network know if the SINR from pico is high enough so that the network node could perform an early pico-to-macro handover or a late macro-to-pico handover. Such mechanisms may help, among other things, avoid frequent HOF or RLF in range extension area.

In some implementations, the network can configure the UE to trigger a mobility event based at least in part on certain metrics such as signal quality measurements. The signal quality measurements can be one or more of pre-processing metrics or post-processing metrics.

As one example, in LTE, the network may configure A2 event (serving RSRQ becomes worse than the threshold) for a pico UE in range extension area so that the network can be notified if the radio quality from the serving pico deteriorates and thus the pico UE can be early handed out to the macro before A3 event happens. Similarly the network may configure A4 event (neighbor RSRQ becomes better than threshold) for a macro UE to avoid the network prematurely handing a macro UE into a pico range extension area. After A3 event happens, the network may postpone the handover until the link quality from pico is sufficiently good. The network node could configure the UE to trigger measurement reports based on RSRQ in addition to RSRP, both of which are associated with pre-processing signal quality. RSRQ is related to the pre-processing SINR. The pre-processing SINR of the UE can refer to the SINR at the antenna connector of the UE or at the front end of the UE receiver.

As another example, the trigger quantity of A2 event can be replaced by or extended to include the post-processing signal quality. For example, the network can be notified by a measurement report if the UE in pico RE area experiences a low post-processing signal quality and the network can hand out the UE to the macro. Similarly, by extending the trigger quantity of A4 event to post-processing signal quality, the network can be notified by the measurement report if the UE sees sufficient post-processing signal quality from the neighboring pico cell and thus the network can hand over the macro UEs in the RE area to the pico cell. Alternatively or additionally, instead of extending A2 and A4 events, new measurement report triggering events can be defined based on the post-processing signal quality.

Using the post-processing signal quality or a representation of the post-processing signal quality can help the network or the UE make a better mobility decision or trigger a mobility event at or close to an optimum point. For example, the post-processing SINR can refer to the SINR at the input of the demodulator and can represent the effective SINR for signal decoding. The post-processing SINR can be a more realistic representation of an actual received signal quality, especially for a UE with an advanced receiver, such as with multiple receiving antennas and interference cancellation/suppression capability. In some cases, the post-processing SINR of a UE with an advanced receiver can be much better than the post-processing SINR of a UE with a simple/baseline receiver, while the two UEs may have the same pre-processing SINR. Using the post-processing SINR in mobility support, the UE with an advanced receiver can connect to the pico cell even if it is at the edge of the RE area, but the UE with a simple/baseline receiver may be handed over to the macro cell well before it reaches the edge of the RE area.

In some implementations, a pre-processing signal quality may be mapped to a post-processing signal quality. As a specific example, the UE may trigger a mobility event based on pre-processing signal quality metric, where the threshold to triggering the mobility event is a pre-processing signal quality corresponding to a desired post-processing signal quality. Depending on the UE interference cancellation/suppression capability, the relationship between the pre- and post-processing signal quality can be complicated and it may be challenging for the network to translate, say, a post-processing SINR threshold to an RSRQ threshold, or to translate a post-processing threshold to a pre-processing threshold for measurement report trigger. In some scenarios, mapping from post-processing values to pre-processing metrics may vary according to the nature of the channel (the extent and nature of multipath fading, etc.). Therefore, in some implementations, it is desirable for the network to be notified a mobility event based at least in part on post-processing signal quality information.

As yet another example, for the case of the UE moving from pico cell range extension area to macro cell, mobility decisions can be made based on some signal quality feedback from the UE, such as channel quality indicator (CQI) or packet error rate (PER). In this case, the serving pico eNB may have certain knowledge of the UE post-processing SINR via the CQI report or PER statistics.

In some implementations, the UE may perform CQI estimation for downlink (DL) and feed back the CQI to the network to, among other things, support link adaptation. For instance, in CQI measurement, the UE may find the highest CQI index (or spectral efficiency) that the UE could support at 10% block error rate corresponding to an assumed PDSCH (Physical Downlink Shared Channel) transmission. The assumed PDSCH transmission usually corresponds to the transmission mode of the UE being configured. For example, if the UE is configured to be in Transmission Mode 1, the assumed PDSCH transmission uses single-antenna port 0 transmission. The CQI measurement can reflect the post-processing signal quality. One example definition of CQI can be found in 3GPP TS 36.213.

In some implementations, the UE can monitor radio link quality. The signal quality used for radio link monitoring may also reflect the post-processing signal quality. For example, the UE measures the DL radio link quality of the serving cell based on CRS (Cell-specific Reference Signal) every radio frame. If a filtered radio link quality becomes lower than threshold Qout, an out-of-sync indicator can be generated. The out-of-sync indicator can be used to detect RLF. In some aspects of implementations, threshold Qout corresponds to signal level of 10% block error rate of a hypothetical PDCCH (Physical Downlink Control Channel) transmission taking into account the PCFICH (Physical Control Format Indicator Channel) error. The hypothetic PDCCH transmission assumes DCI (Downlink Control Information) format 1A with aggregation level of 8 for system bandwidth larger than 3 MHz.

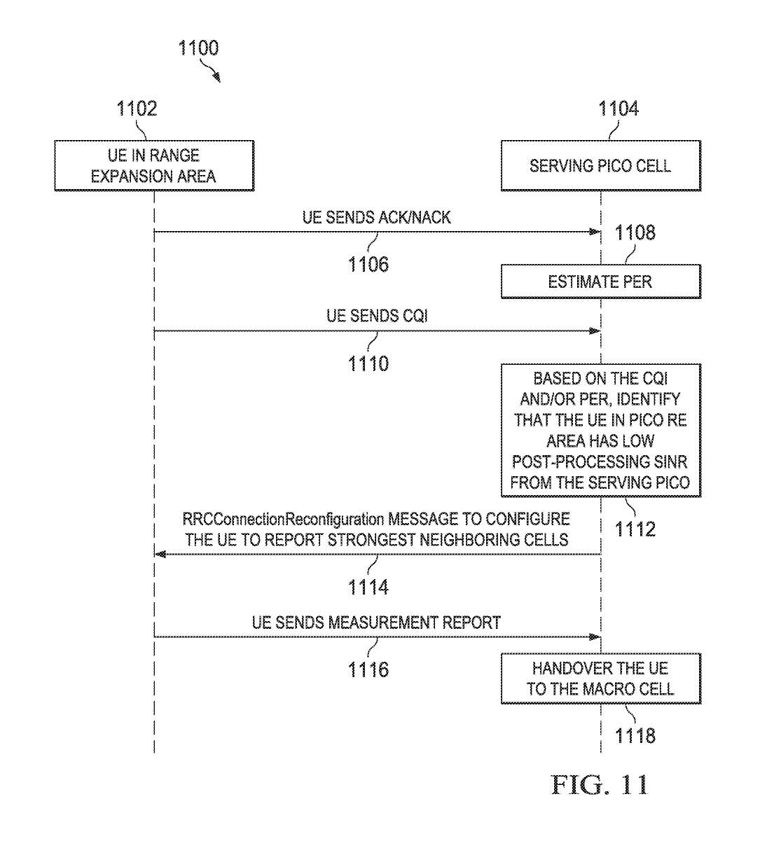

FIG. 11 is a flow chart 1100 illustrating an example signal flow of measurement report triggering based on feedback from a UE. In the illustrated example, a UE 1102 is located in range extension area of a pico cell 1104. The pico cell 1104 may be the current serving cell of the UE 1102. In some instances, the UE 1102 may send Acknowledgement (ACK)/Non-acknowledgement (NACK) feedback to the pico cell 1104 at 1106. Based on the ACK/NACK, the pico cell 1104 can estimate the PER (Packet Error Rate) over a time window at 1108. With the knowledge of the PER and the configured MCS (Modulation and Coding Scheme), an estimate of post-processing SINR can be obtained. If a high PER with one-layer transmission and lowest MCS level is observed, it may indicate a weak post-processing SINR. If the estimated post-processing SINR is lower compared to a SINR target (e.g., configured by the eNB), the UE may need to be handed over to a macro cell. The SINR target may be derived based on the required error rate target on PDCCH or error rate target on any other essential RRC messages expected by the cell. The essential messages may include RRC reconfiguration messages.

Alternatively or additionally, the UE 1102 may send a CQI report to the pico cell 1104 at 1110. For example, the UE 1102 may send N consecutive CQI reports with index 0 for one-layer transmission (CQI index 0 means that UE cannot support the lowest MCS), which may be a good indication that the post-processing SINR is very low and the network expects to handover the UE 1102 to a macro base station.

At 1112, based on the CQI and/or PER, the pico cell 1104 may identify whether the UE 1102 in the pico range extension area has sufficient good post-processing signal quality. If the pico cell identifies that a UE in pico range extension area has low post-processing signal quality at 1112, the pico cell 1104 can configure the UE 1102 to perform measurement reporting by, for example, RRCConnectionReconfiguration message at 1114, wherein the IE ReportConfigEUTRA may specify periodical reporting with purpose of reportStrongestCells. In this case the UE may report the RSRP and RSRQ of the serving pico base station 1104 as well as the RSRP and/or RSRQ of the strongest neighboring cells. At 1116, the UE 1102 may send the measurement report to the pico cell 1104. The pico cell can pick an appropriate neighboring cell (for example, a macro cell) to handover the UE 1102 at 1118.

In some implementations, the serving pico cell may not be able to get the post-processing signal quality information for the PDSCH (Physical Downlink Shared Channel) from CQI or PER statistics. For example, if the UE is with bursty traffic, the UE may not be configured with periodic CQI feedback in order to save the UL control resources and instead the network may configure the UE to send aperiodic CQI when new data arrives. Similarly, if the UE is with bursty traffic, the base station may not have the PER statistics during the traffic idle period. In these cases, the UE may need to notify the base station when the post-processing signal quality gets lower than a threshold.

Example implementations of using post-processing metrics for mobility support in LTE are discussed in further detail.

For handover from pico cell to macro cell in the range extension area, the trigger quantity and/or report quantity of Event A2 can be extended to include post-processing signal quality in addition to RSRP and RSRQ. As shown in TABLE 1, the additional trigger/report quantity post-processing signal quality can be added in the IE (Information Element) ReportConfigEUTRA specified in TS36.331. Note that the specification modification shown in TABLE 1 can allow the post-processing signal quality to be the trigger/report quantity for all other measurement report trigger events (such as, Event A1 to A6, B1, B2).

TABLE 1
Additional trigger and report quantity in IE ReportConfigEUTRA
ReportConfigEUTRA information element

-- ASN1START

| ReportConfigEUTRA ::= | | SEQUENCE { |
|---|---|---|
| | triggerType | CHOICE { |

| | |
|---|---|
| event | SEQUENCE { |

| | |
|---|---|
| eventId | CHOICE { |

| | |
|---|---|
| eventA1 | SEQUENCE { |

| | |
|---|---|
| a1-Threshold | ThresholdEUTRA |

| }, | |
|---|---|
| eventA2 | SEQUENCE { |

| | |
|---|---|
| a2-Threshold | ThresholdEUTRA |
| a2-ReportNeighbor | BOOLEAN |

| }, | |
|---|---|
| eventA3 | SEQUENCE { |

| | |
|---|---|
| a3-Offset | INTEGER (−30..30), |
| reportOnLeave | BOOLEAN |

| }, | |
|---|---|
| eventA4 | SEQUENCE { |

| | |
|---|---|
| a4-Threshold | ThresholdEUTRA |

| }, | |
|---|---|
| eventA5 | SEQUENCE { |

| | |
|---|---|
| a5-Threshold1 | ThresholdEUTRA, |
| a5-Threshold2 | ThresholdEUTRA |

| }, | |
|---|---|
| ..., | |
| eventA6-r10 | SEQUENCE { |

| | |
|---|---|
| a6-Offset-r10 | INTEGER (−30..30), |
| a6-ReportOnLeave-r10 | BOOLEAN |

}

| }, | |
|---|---|
| hysteresis | Hysteresis, |
| timeToTrigger | TimeToTrigger |

| }, | |
|---|---|
| periodical | SEQUENCE { |

| | |
|---|---|
| purpose | ENUMERATED { |

reportStrongestCells, reportCGI}

}

| }, | |
|---|---|
| triggerQuantity | ENUMERATED {rsrp, rsrq, post-processing signal |

quality},

| | |
|---|---|
| reportQuantity | ENUMERATED {sameAsTriggerQuantity, |

allThree, rsrpAndrsrq, rsrpAndpostprocessingsignalquality,
rsrqAndpostprocessingsignalquality},

| | |
|---|---|
| maxReportCells | INTEGER (1..maxCellReport), |

| | |
|---|---|
| reportInterval | ReportInterval, |
| reportAmount | ENUMERATED {r1, r2, r4, r8, r16, r32, r64, infinity}, |

| ..., | | |
|---|---|---|
| [[ si-RequestForHO-r9 | ENUMERATED {setup} | OPTIONAL, - |

- Cond reportCGI

| | | |
|---|---|---|
| ue-RxTxTimeDiffPeriodical-r9 | ENUMERATED {setup} | OPTIONAL -- |

Need OR

| ]], | | |
|---|---|---|
| [[ includeLocationInfo-r10 | ENUMERATED {true} | OPTIONAL, - |

- Cond reportMDT

| | | |
|---|---|---|
| reportAddNeighMeas-r10 | ENUMERATED {setup} | OPTIONAL - |

- Need OR

]]

}

| | |
|---|---|
| ThresholdEUTRA ::= | CHOICE{ |

| | |
|---|---|
| threshold-RSRP | RSRP-Range, |
| threshold-RSRQ | RSRQ-Range |

| | |
|---|---|
| threshold-postprocessingsignalquality | postprocessingsignalquality-Range |

}
-- ASN1STOP

ReportConfigEUTRA field descriptions

a2-ReportNeighbor
One bit to indicate the UE to include the neighboring cell measurements into the measurement
report triggered by A2 event

The IE MeasResults can also be modified to allow the UE to include the post-processing signal quality in the measurement report as shown in TABLE 2.

TABLE 2
Include post-processing signal quality in the measurement report
MeasResults information element

-- ASN1START

| MeasResults ::= | | SEQUENCE { |
|---|---|---|
| | measId | MeasId, |
| | measResultPCell | SEQUENCE { |

| | |
|---|---|
| rsrpResult | RSRP-Range, |
| rsrqResult | RSRQ-Range |

| | |
|---|---|
| post-processingsignalqualityResult | postprocessingsignalquality-Range |

| OPTIONAL | |
|---|---|
| }, | |
| measResultNeighCells | CHOICE { |

| | |
|---|---|
| measResultListEUTRA | MeasResultListEUTRA, |
| measResultListUTRA | MeasResultListUTRA, |

| | |
|---|---|
| measResultListGERAN | MeasResultListGERAN, |
| measResultsCDMA2000 | MeasResultsCDMA2000, |

...

| | |
|---|---|
| } | OPTIONAL, |

| ..., | | |
|---|---|---|
| [[ measResultForECID-r9 | MeasResultForECID-r9 | OPTIONAL |

| ]], | | |
|---|---|---|
| [[ locationInfo-r10 | LocationInfo-r10 | OPTIONAL, |

| | | |
|---|---|---|
| measResultServFreqList-r10 | MeasResultServFreqList-r10 | OPTIONAL |

]]

}

| | |
|---|---|
| MeasResultListEUTRA ::= | SEQUENCE (SIZE (1..maxCellReport)) OF |

MeasResultEUTRA
MeasResultEUTRA ::= SEQUENCE {

| | |
|---|---|
| physCellId | PhysCellId, |
| cgi-Info | SEQUENCE { |

| cellGlobalId | CellGlobalIdEUTRA, | |
|---|---|---|
| trackingAreaCode | TrackingAreaCode, | |
| plmn-IdentityList | PLMN-IdentityList2 | OPTIONAL |

| | |
|---|---|
| } | OPTIONAL, |

| | |
|---|---|
| measResult | SEQUENCE { |

| | | |
|---|---|---|
| rsrpResult | RSRP-Range | OPTIONAL, |
| rsrqResult | RSRQ-Range | OPTIONAL, |

| | |
|---|---|
| post-processingSignalqualityResult | postprocessingSignalquality-Range |

OPTIONAL

| ..., | | |
|---|---|---|
| [[ additionalSI-Info-r9 | AdditionalSI-Info-r9 | OPTIONAL |

]]

}

}

| | |
|---|---|
| MeasResultServFreqList-r10 ::= | SEQUENCE (SIZE (1..maxServCell-r10)) OF |

MeasResultServFreq-r10

| MeasResultServFreq-r10 ::= | | SEQUENCE { |
|---|---|---|
| | servFreqId-r10 | ServCellIndex-r10, |

| | |
|---|---|
| measResultSCell-r10 | SEQUENCE { |

| | |
|---|---|
| rsrpResultSCell-r10 | RSRP-Range, |
| rsrqResultSCell-r10 | RSRQ-Range |

| | |
|---|---|
| post-processingSignalqualityResult | postprocessingSignalquality-Range |

| OPTIONAL | |
|---|---|
| } | OPTIONAL, |

| | |
|---|---|
| measResultBestNeighCell-r10 | SEQUENCE { |

| | |
|---|---|
| physCellId-r10 | PhysCellId, |

| | |
|---|---|
| rsrpResultNCell-r10 | RSRP-Range, |
| rsrqResultNCell-r10 | RSRQ-Range |

| | |
|---|---|
| post-processingSignalqualityResult | postprocessingSignalquality-Range |

| OPTIONAL | |
|---|---|
| } | OPTIONAL, |

...

}

| | |
|---|---|
| MeasResultListUTRA ::= | SEQUENCE (SIZE (1..maxCellReport)) OF |

MeasResultUTRA
MeasResultUTRA ::= SEQUENCE {

| | |
|---|---|
| physCellId | CHOICE { |

| | |
|---|---|
| fdd | PhysCellIdUTRA-FDD, |
| tdd | PhysCellIdUTRA-TDD |

| }, | |
|---|---|
| cgi-Info | SEQUENCE { |

| cellGlobalId | CellGlobalIdUTRA, | |
|---|---|---|
| locationAreaCode | BIT STRING (SIZE (16)) | OPTIONAL, |

| | | |
|---|---|---|
| routingAreaCode | BIT STRING (SIZE (8)) | OPTIONAL, |

| | | |
|---|---|---|
| plmn-IdentityList | PLMN-IdentityList2 | OPTIONAL |

| | |
|---|---|
| } | OPTIONAL, |

| | |
|---|---|
| measResult | SEQUENCE { |

| | | |
|---|---|---|
| utra-RSCP | INTEGER (−5..91) | OPTIONAL, |

| | | |
|---|---|---|
| utra-EcN0 | INTEGER (0..49) | OPTIONAL, |

| ..., | | |
|---|---|---|
| [[ additionalSI-Info-r9 | AdditionalSI-Info-r9 | OPTIONAL |

]]

}

}

| | |
|---|---|
| MeasResultListGERAN ::= | SEQUENCE (SIZE (1..maxCellReport)) OF |

MeasResultGERAN
MeasResultGERAN ::=SEQUENCE {

| | |
|---|---|
| carrierFreq | CarrierFreqGERAN, |
| physCellId | PhysCellIdGERAN, |
| cgi-Info | SEQUENCE { |

| | |
|---|---|
| cellGlobalId | CellGlobalIdGERAN, |

| | | |
|---|---|---|
| routingAreaCode | BIT STRING (SIZE (8)) | OPTIONAL |

| | |
|---|---|
| } | OPTIONAL, |

| | |
|---|---|
| measResult | SEQUENCE { |

| | |
|---|---|
| rssi | INTEGER (0..63), |

...

}

}

| MeasResultsCDMA2000 ::= | | SEQUENCE { |
|---|---|---|
| | preRegistrationStatusHRPD | BOOLEAN, |
| | measResultListCDMA2000 | MeasResultListCDMA2000 |

}

| | |
|---|---|
| MeasResultListCDMA2000 ::= | SEQUENCE (SIZE (1..maxCellReport)) OF |

MeasResultCDMA2000
MeasResultCDMA2000 ::=SEQUENCE {

| physCellId | PhysCellIdCDMA2000, | |
|---|---|---|
| cgi-Info | CellGlobalIdCDMA2000 | OPTIONAL, |

| | |
|---|---|
| measResult | SEQUENCE { |

| | | |
|---|---|---|
| pilotPnPhase | INTEGER (0..32767) | OPTIONAL, |

| | |
|---|---|
| pilotStrength | INTEGER (0..63), |

...

}

}

| | |
|---|---|
| MeasResultForECID-r9 ::= | SEQUENCE { |

| | |
|---|---|
| ue-RxTxTimeDiffResult-r9 | INTEGER (0..4095), |
| currentSFN-r9 | BIT STRING (SIZE (10)) |

}

| | |
|---|---|
| PLMN-IdentityList2 ::= | SEQUENCE (SIZE (1..5)) OF PLMN-Identity |

| | |
|---|---|
| AdditionalSI-Info-r9 ::= | SEQUENCE { |

| | | |
|---|---|---|
| csg-MemberStatus-r9 | ENUMERATED {member} | OPTIONAL, |

| | | |
|---|---|---|
| csg-Identity-r9 | CSG-Identity | OPTIONAL |

}
-- ASN1STOP

The description of Event A2 in TS36.331 can also be modified to include the post-processing signal quality. As an example, the modification of Event A2 is shown in TABLE 3.

TABLE 3
Modified description of Event A2
5.5.4.3 Event A2 (Serving becomes worse than threshold)

```
The UE shall:
  1> consider the entering condition for this event to be satisfied when
  condition A2-1, as specified
```

below, is fulfilled;

```
  1> consider the leaving condition for this event to be satisfied when
  condition A2-2, as specified
```

below, is fulfilled;

```
  1> for this measurement, consider the primary or secondary cell that
  is configured on the frequency
```

indicated in the associated measObjectEUTRA to be the serving cell;

```
Inequality A2-1 (Entering condition)
Ms+Hys < Thresh
Inequality A2-2 (Leaving condition)
Ms−Hys > Thresh
The variables in the formula are defined as follows:
  Ms is the measurement result of the serving cell, not taking into
  account any offsets.
  Hys is the hysteresis parameter for this event (i.e. hysteresis as
  defined within reportConfigEUTRA for
```

this event).

```
  Thresh is the threshold parameter for this event (i.e. a2-Threshold as
  defined within
```

reportConfigEUTRA for this event).

```
  Ms is expressed in dBm in case of RSRP, or in dB in case of RSRQ
  and post-processing signal
```

quality.

```
  Hys is expressed in dB.
  Thresh is expressed in the same unit as Ms.
```

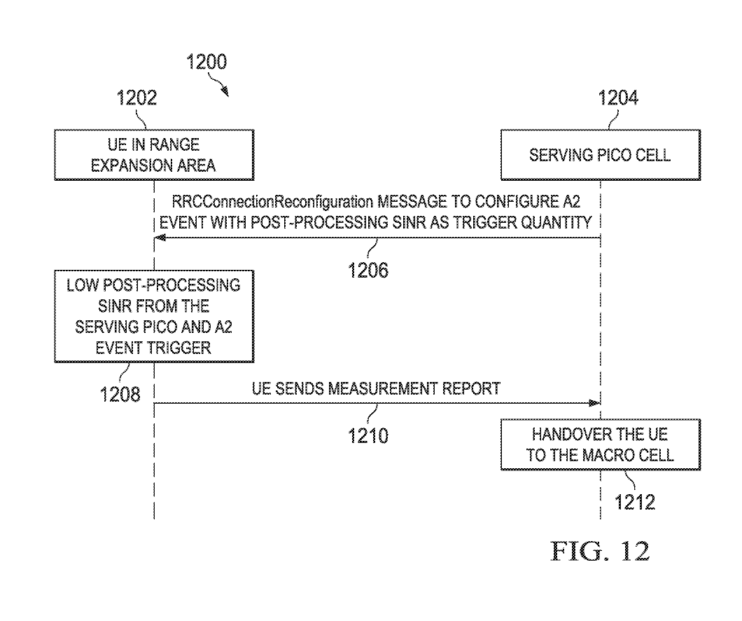

FIG. 12 is a flow chart 1200 illustrating an example signal flow of measurement report triggering based on post-processing signal quality measurement at the UE. In the illustrated example, a UE 1202 is located in the range extension area of a serving pico cell 1204. At 1206, the serving pico cell 1204 may send an RRCConnetionReconfiguration message to the UE to configure A2 event based at least in part on some post-processing signal metrics. For instance, the A2 event can be configured based on the modified A2 event as illustrated in TABLE 3. In some implementations, the A2 event may be configured based on post-processing signal quality such as post-processing SINR. At 1208, the UE 1202 may identify a low post-processing signal quality, for example, the post-processing signal quality of the UE below a threshold, and thus the A2 event is triggered. At 1210, the UE 1202 can send a measurement report to the pico cell 1204. The pico cell 1204 can then make RRM decisions based on the measurement report that the UE provided. For example, the pico base station 1204 may select a best neighboring cell based on one or more of RSRP, RSRQ, or a post-processing signal quality and then hand over the UE 1202 to the best neighboring cell.

In addition to incorporating post-processing signal quality in the trigger/report quantity, some extra control information can be included in the IE ReportConfigEUTRA to instruct the UE to include the neighboring cell measurements into the measurement report triggered by A2 event. As a specific example, in TABLE 1, a one-bit field a2-ReportNeighbor is added in the IE ReportConfigEUTRA. This additional control information may help reduce the delay in the handover procedure. Because if the base station receives a UE measurement report only including the serving cell's measurements when the A2 event is triggered, to select an appropriate target HO cell, the eNB needs to separately configure the UE to report the measurements of neighboring cells and this could cause extra delay for handover.

In an alternative implementation, instead of extending the A2 event to include post-processing signal quality, a new measurement report triggering event (e.g., Event A7) can be defined for serving cell's post-processing signal quality below threshold.

In some implementations, the measurement report triggering and the report quantity can be based on some representation of post-processing signal quality. For example, A2 event could be triggered based on the PDCCH performance. Similar to the criteria of RLF detection, the UE could trigger A2 event if the average error rate of a hypothetical PDCCH transmission possibly using a predetermined DCI format and/or taking into account the PCFICH errors over a certain time period is higher than threshold Y % (e.g., 10%). The same hypothetical PDCCH transmission parameters used for RLF detection (such as shown in Table 7.6.1-1 or 7.6.1-2 in 3GPP TS36.133) could be used here. Alternatively, the UE could trigger A2 event if the average post-processing signal quality over a certain time period is lower than a value where this value is the post-processing signal level corresponding to Y % block error rate of the hypothetical PDCCH transmission taking into account the PCFICH errors. Similarly, if the UE receives EPDCCH (Enhanced Physical Downlink Control Channel), the trigger event can use the block error rate of a hypothetical EPDCCH transmission using a predetermined DCI format instead of one based on PDCCH. Yet in another alternative, the measurement report triggering could be based on the PDSCH performance. Similar to the criteria of UE deriving CQI value, the UE could trigger A2 event if the block error probability of a hypothetical PDSCH transport block with the lowest MCS and a certain transmission mode (e.g., transmission mode 1 through 10 as defined in TS36.213 and elsewhere) occupying a group of reference PRBs (Physical Resource Blocks) exceeds threshold Z % (e.g., 10%). The same assumptions for the reference PRBs used for CQI derivation (described in Section 7.2.3 in TS36.213) could be used here. In yet another alternative, the measurement report triggering could be based on the PDSCH spectral efficiency that can be supported under the measured channel conditions at a predetermined block error rate such as 10% block error rate. The PDSCH spectral efficiency can be calculated as CQI using the procedures such as described in Section 7.2.3 of 3GPP TS 36.213. The measurement report can be triggered when the calculated CQI either exceeds or falls below a threshold spectral efficiency or channel quality indication. The report quantity could be the spectral efficiency the UE can support at a predetermined block error rate such as 10% block error rate for an assumed PDSCH transmission mode such as transmit diversity or single antenna port 0 transmission.

In the case of LTE handover from macro cell to pico cell in the range extension area, when a macro UE is moving towards the pico range extension area, the A3 event may typically be triggered first. To ensure a successful HO, the network may not handover the UE to the target pico right away after the A3 event. Instead the network may delay the handover until the post-processing signal quality from the pico is above a certain threshold. This may involve extra processing at the UE to calculate the post-processing signal quality for a neighboring cell based on reference signals such as CRS or CSI-RS. In this case, the UE may need to notify the network when the post-processing signal quality from the neighboring pico cell is high enough. To achieve this, similar to the A2 event in case of handover from a pico RE area to a macro cell, the trigger quantity and/or report quantity of Event A4 can be extended to include post-processing signal quality in addition to RSRP and RSRQ such as shown in TABLE 1.

The post-processing signal quality could be included in measurement report such as shown in TABLE 2. The description of Event A4 in 3GPP TS36.331 can also be modified to include the post-processing signal quality as shown in TABLE 4.

TABLE 4
Modified description of Event A4
5.5.4.5 Event A4 (Neighbor becomes better than threshold)

```
The UE shall:
  1> consider the entering condition for this event to be satisfied
  when condition A4-1, as specified
```

below, is fulfilled;

```
  1> consider the leaving condition for this event to be satisfied
  when condition A4-2, as specified
```

below, is fulfilled;

```
Inequality A4-1 (Entering condition)
Mn+Ofn+Ocn−Hys > Thresh
Inequality A4-2 (Leaving condition)
Mn+Ofn+Ocn+Hys < Thresh
The variables in the formula are defined as follows:
  Mn is the measurement result of the neighboring cell, not taking
  into account any offsets.
  Ofn is the frequency specific offset of the frequency of the
  neighbor cell (i.e. offsetFreq as defined
```

within measObjectEUTRA corresponding to the frequency of
the neighbor cell).

```
  Ocn is the cell specific offset of the neighbour cell (i.e.
  cellIndividualOffset as defined within
```

measObjectEUTRA corresponding to the frequency of the
neighbor cell), and set to zero if not
configured for the neighbor cell.

```
  Hys is the hysteresis parameter for this event (i.e. hysteresis as defined
  within reportConfigEUTRA for
```

this event).

```
  Thresh is the threshold parameter for this event (i.e. a4-Threshold as
  defined within
```

reportConfigEUTRA for this event).

```
  Mn is expressed in dBm in case of RSRP, or in dB in case of RSRQ
  and post-processing signal
```

quality.

```
  Ofn, Ocn, Hys are expressed in dB.
  Thresh is expressed in the same unit as Ms.
```

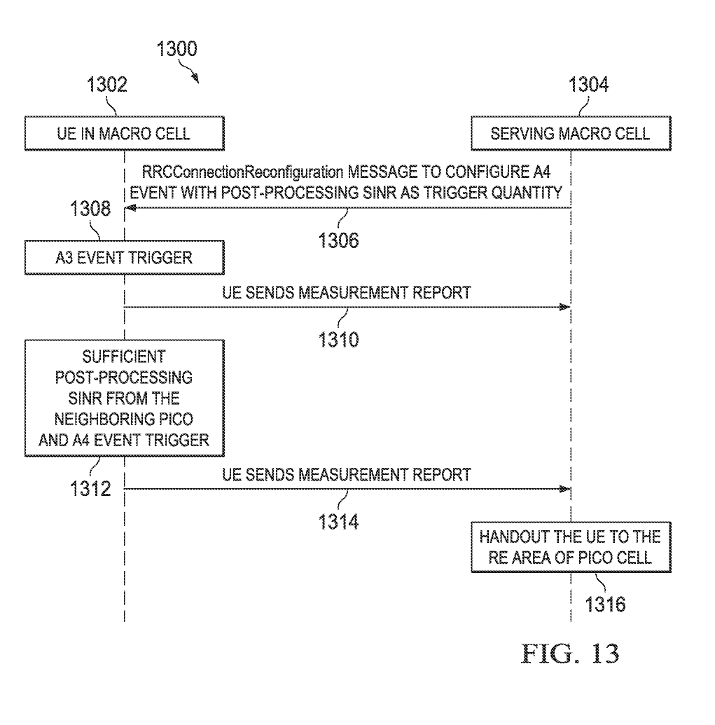

FIG. 13 is a flow chart 1300 illustrating an example signal flow of measurement report triggering based on post-processing signal quality measurement at a UE. In the illustrated example, a UE 1302 is located in a coverage area of a macro cell 1304. The macro cell 1304 can be the serving base station of the UE 1302. At 1306, the serving macro cell 1304 may send an RRCConnetionReconfiguration message to the UE 1302 to configure A4 event based at least in part on some post-processing signal metrics. For instance, the A4 event can be configured based on the modified A4 event as illustrated in TABLE 1 with post-processing signal quality included as a trigger quantity. In some implementations, the A4 event may be configured based on post-processing signal quality such as post-processing SINR. At 1308, A3 event is triggered where, for example, the UE 1302 identifies a signal quality of a neighboring cell becomes offset better than that of the serving macro cell 1304. At 1310, the UE 1302 may send a measurement report to the serving macro cell 1304. When the UE 1302 identifies the post-processing signal quality of the neighboring cell (e.g., a pico cell) is high enough, A4 event can be triggered at 1312. The UE 1302 may send a measurement report triggered by A4 event to the macro cell 1304 at 1314. In some implementations, the measurement report triggered by A4 event can include measurements of serving cell as well as the neighboring cell which triggered the A4 event. The macro cell 1304 can determine a target HO cell based on the measurement report triggered by A4 event and handover the UE 1302 to the target cell at 1316.

In an alternative implementation, instead of extending the A4 event to include post-processing signal quality, a new measurement report triggering event can be defined for neighboring cell's post-processing signal quality below a threshold.

In some implementations, the A4 event could also be triggered based on some representation of post-processing signal quality such as the error rate of a hypothetical PDCCH transmission or a hypothetical PDSCH transmission with lowest MCS and a certain transmission mode, or the spectral efficiency of a hypothetical PDSCH transmission.

In the case of UTRAN, UE mobility can be classified into UE-controlled mobility and network-controlled mobility. In both cases, mobility decisions can be made based on pre-processing signal quality, such as pilot RSCP, Ec/N0 or path loss.

In CELL_FACH (Forward Access Channel) and CELL_DCH (Dedicated Channel) states of UTRAN, CQI may be measured and reported by the UE to the network. Current standard specifications mandate that CELL_FACH mobility procedures are based on pre-processing measurements. In CELL_DCH, CQI is terminated in the Node B which does not govern mobility, as opposed to the RNC.

Similar to the mobility support in LTE, the RRM decision in UTRAN can also be made based at least in part on post-processing signal quality. For example, the measurement report and cell selection/reselection triggers and measured values can be replaced by or extended to post-processing signal quality. These triggers or values can be referred to as “measurement quantities” in 3GPP TS25.331 and “cell quality value” or “cell RX level value” in 3GPP TS25.304. As an example, post-processing signal quality can be added to the list of measurement quantities as shown in TABLE 5.

TABLE 5
Post-processing signal quality as the
measurement quantity for handover in UTRA
25.331 measurement quantities:

| | |
|---|---|
| 1 | Downlink E_{c}/N₀. |
| 2 | Downlink path loss. |
| | For FDD: |
| | Pathloss in dB = Primary CPICH Tx power − CPICH |
| | RSCP. |
| | For Primary CPICH Tx power the IE “Primary CPICH Tx |
| | power” shall be used. |

The unit is dBm.

```
  CPICH RSCP is the result of the CPICH RSCP measurement.
  The unit is dBm.
For TDD:
  Pathloss in dB = Primary CCPCH TX power − Primary
  CCPCH RSCP.
  For Primary CCPCH TX power the IE “Primary CCPCH TX
  Power” shall be
```

used. The unit is dBm.

```
  Primary CCPCH RSCP is the result of the Primary CCPCH RSCP
  measurement.
```

The unit is dBm.

| | |
|---|---|
| | If necessary Pathloss shall be rounded up to the next higher |
| | integer. |
| | Results higher than 158 shall be reported as 158. |
| | Results lower than 46 shall be reported as 46. |
| 3 | Downlink received signal code power (RSCP) after despreading. |
| 4 | ISCP measured on Timeslot basis. |
| 5 | <NEW QUANTITY:> Post-processing signal quality |

In some implementations, for both LTE and UTRAN, the handover procedure during RRC connected state may include some or all of the following steps:
a. The UE informs the network of its ability to measure the post-processing signal quality.
b. The network configures the UE to provide post-processing signal quality measurements. This may include a minimum threshold.
c. The post-processing signal quality is conveyed by the UE to the network. For example, it is conveyed to the RNC in case of UTRA or eNB in case of LTE, either as a standalone measurement or accompanying other, previously defined measurements. The post-processing signal quality may be signalled explicitly or implicitly (e.g., if a trigger condition for transmitting a message is based on the post-processing signal quality). The MEASUREMENT_REPORT message or a new message can be used to achieve this. In another example for UTRA, the post-processing signal quality is conveyed by the UE to the Node B and then forwarded from the Node B to the RNC over the Iub interface.
d. The RNC or eNB makes handover decision(s) using the additional measurement in the form of post-processing signal quality. The decision criteria are left to RNC or eNB implementation, but could be based, for example, on post-processing signal quality of the target cell exceeding the serving cell post-processing signal quality.

The UE may be capable of measuring and/or reporting post-processing signal quality of own cell only, or of its own cell as well as one or more neighboring cells.

It should be understood that post-processing signal quality may be derived, signalled or taken as basis of mobility decisions either alone or in combination with other measurement entities such as pilot strength, quality or path loss.

In some implementations, for cell selection/reselection during RRC idle state, CELL_FACH or CELL_PCH state, post-processing signal quality can added to the list of measurement quantities as shown in TABLE 6 and TABLE 7 for UTRA and LTE, respectively. It will be straightforward to those skilled in the art to implement further specification updates that propagate the proposed addition to other relevant places in the 3GPP specifications.

As a specific example, the cell selection/reselection procedure may include some or all of the following steps:
a. The network informs the UE that it may base cell selection or reselection on post-processing signal quality measurements.
b. The UE measures the post-processing signal quality, if it has the ability.
c. The UE makes the cell selection or reselection decision using the additional measurement in the form of post-processing signal quality. The decision criteria can be as per existing criteria in 3GPP TS 25.304 section 5 in the case of UTRA or 3GPP TS 36.304 section 5 in the case of LTE, or any other appropriate criteria.

The UE may be capable of measuring and/or reporting the post-processing signal quality of own cell only, or of its own cell as well as one or more neighboring cells.

It should be understood that post-processing signal quality may be derived, signalled between network entities or taken as basis of mobility decisions either alone or in combination with other measurement entities such as pilot strength, quality or path loss.

TABLE 6
Post-processing signal quality as the measurement
quantity for cell (re)selection in UTRA

| | |
|---|---|
| Squal | Cell Selection quality value (dB) |
| | Applicable only for FDD cells. |
| Srxlev | Cell Selection RX level value (dB) |
| Q_{qualmeas} | Measured cell quality value. The quality of the |
| | received signal expressed in CPICH E_{c}/N₀ (dB) |
| | for FDD cells. CPICH Ec/N0 shall be averaged as |
| | specified in [10]. Applicable only for FDD cells. |
| | <NEW TEXT:> post-processing signal quality |
| | value. |
| Qᵣₓₗₑᵥₘₑₐₛ | Measured cell RX level value. This is |
| | received signal, CPICH RSCP for FDD cells |
| | (dBm) and P-CCPCH RSCP for TDD cells (dBm). |
| Qqualmin | Minimum required quality level in the cell |
| | (dB). Applicable only for FDD cells. |
| QqualminOffset | Offset to the signalled Qqualmin taken into |
| | account in the Squal evaluation as a result of |
| | a periodic search for a higher priority PLMN |
| | while camped normally in a VPLMN [5] |
| Qrxlevmin | Minimum required RX level in the cell (dBm) |
| QrxlevminOffset | Offset to the signalled Qrxlevmin taken into |
| | account in the Srxlev evaluation as a result |
| | of a periodic search for a higher priority |
| | PLMN while camped normally in a VPLMN [5] |
| Pcompensation | max(UE_TXPWR_MAX_RACK − P_MAX, 0) |
| | (dB) |
| UE_TXPWR_{—} | Maximum TX power level an UE may use when |
| MAX_RACH | accessing the cell on RACH (read in system |
| | information) (dBm) |
| P_MAX | Maximum RF output power of the UE (dBm) |

TABLE 7
Post-processing signal quality as measurement
quantity for cell (re)selection in LTE

| | |
|---|---|
| Srxlev | Cell selection RX level value (dB) |
| Squal | Cell selection quality value (dB) |
| Qᵣₓₗₑᵥₘₑₐₛ | Measured cell RX level value (RSRP) |
| Q_{qualmeas} | Measured cell quality value (RSRQ or post-processing |
| | signal quality) |
| Qᵣₓₗₑᵥₘᵢₙ | Minimum required RX level in the cell (dBm) |
| Q_{qualmin} | Minimum required quality level in the cell (dB) |
| Q_{rxlevminoffset} | Offset to the signalled Qᵣₓₗₑᵥₘᵢₙ taken into account in the |
| | Srxlev evaluation as a result of a periodic search for a |
| | higher priority PLMN while camped normally in a |
| | VPLMN [5] |
| Q_{qualminoffset} | Offset to the signalled Q_{qualmin} taken into account in the |
| | Squal evaluation as a result of a periodic search for a |
| | higher priority PLMN while camped normally in a |
| | VPLMN [5] |
| Pcompensation | max(P_{EMAX} − P_{PowerClass}, 0) (dB) |
| P_{EMAX} | Maximum TX power level an UE may use when |
| | transmitting on the uplink in the cell (dBm) defined as |
| | P_{EMAX} in [TS 36.101] |
| P_{PowerClass} | Maximum RF output power of the UE (dBm) according |
| | to the UE power class as defined in [TS 36.101] |

In some implementations, post-processing signal quality is employed to assist intra-frequency mobility.

In some implementations, post-processing signal quality is employed to assist inter-frequency mobility.

In some implementations, post-processing signal quality is employed to assist inter-RAT mobility.

In the following, some specific example procedures are described in detail for the UE to identify a post-processing metric. The post-processing metric can be one or more of a post-processing signal quality or a representation of post-processing signal quality. In some implementations, the post-processing metric can be identified based on measurement of a post-processing signal at the output of the receiver processing module (e.g., 506 in FIG. 5). The measurement can be based at least in part on one or more of an estimated channel response between a transmit and receive antenna pair, interference statistics, a block error rate, or a transmission mode.

In some implementations, based on reference signals such as CRS or CSI-RS, the UE can measure the channel coefficients with respect to each transmit and receive antenna pair as well as the interference statistics. The post-processing signal quality can be estimated as

γ=ƒ({Ĉ₁,Ĉ₂, . . . , Ĉ_{N×M}}, \hat{N}₀)

where Ĉₖ can be a set of values comprising the estimated channel response over part or all of the system bandwidth on the kth transmit and receive antenna pair, N and M are the number of transmit and receive antennas, respectively; and \hat{N}₀ represents the interference statistics which could be a matrix in case of multiple receiving antennas. The function ƒ( ) can be UE implementation specific which could depend on the UE receiver algorithm and interference cancellation/suppression capability. In some implementations, the values of ƒ( ) may be pre-calculated and stored in the form of a look-up table.

As one example, ƒ( ) is a measure of the traffic channel spectral efficiency (SE) that can be supported given the set of Ĉₖ values and \hat{N}₀ at a predetermined block error rate such as 10% block error rate. The traffic channel spectral efficiency can be calculated similar to the CQI estimation procedure described in Section 7.2.3 of 3GPP TS 36.213 for PDSCH, or Section 6A.2 of 3GPP TS 25.214 for HS-DSCH. One example definition of the PDSCH spectral efficiency (SE) measurement is shown in TABLE 8. Another example definition, for HS-PDSCH (High-Speed Physical Downlink Shared Channel) spectral efficiency is shown in TABLE 9. The SE measurement in TABLE 8 assumes the PDSCH transmission scheme to be single-antenna port 0 transmission if the number of PBCH (Physical Broadcast Channel) antenna ports is one, and to be transmit diversity otherwise. One difference between the SE measurement in TABLE 8 and the CQI measurement is that CQI measurement assumes a PDSCH transmission scheme which corresponds to the transmission mode the UE being configured.

For LTE, the proposed post-processing measurement such as the SE measurement in TABLE 8 can be a modified version of CQI—it is not exactly the same as CQI. In LTE there are a number of transmission modes, e.g., transmit diversity, open-loop spatial multiplexing, close-loop spatial multiplexing etc. Based on the UE radio channel condition, the UE can be configured to be in one of the transmission modes and the CQI measurement can be based on the transmission mode the UE configured. In one example post-processing measurement such as the SE measurement in TABLE 8, the UE measures the spectral efficiency corresponding to the transmission mode of transmit diversity if the eNB has multiple transmit antennas. (One reason to choose transmit diversity is that it is the most conservative transmission mode. Usually transmit diversity is configured for cell-edge UE).

TABLE 8
One example of the definition of the
PDSCH spectral efficiency measurement

The UE shall measure the spectral efficiency (SE) as the highest SE
index between 1 and 15 in the 4-bit Spectral Efficiency Table which
satisfies the following condition, or index 0 if index 1 does not
satisfy the condition:
A single PDSCH transport block with a combination of modulation
scheme and code rate corresponding to the SE index, and occupying a
group of downlink physical resource blocks, could be received with a
transport block error probability not exceeding 0.1.
The UE shall assume the following for the purpose of deriving the SE
index:
Redundancy Version 0
If CSI-RS is used for channel measurements, the ratio of PDSCH EPRE
to CSI-RS EPRE is assumed to be 0 dB.
The PDSCH transmission mode is assumed to be single-antenna port 0
transmission if the number of PBCH antenna ports is one; otherwise
transmit diversity.
If CRS is used for channel measurements, the ratio of PDSCH EPRE to
cell-specific RS EPRE is assumed to be 0 dB.

4-bit spectral efficiency Table

| | | | |
|---|---|---|---|
| SE index | modulation | code rate × 1024 | SE |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

TABLE 9
One example of HS-PDSCH spectral efficiency
measurement (CQI table G, TS 25.214).

| CQI | Transport | Number | | Reference | | |
|---|---|---|---|---|---|---|
| value | Block Size | of | Modulation | power | NIR | XRV |
| 0 | N/A | Out of range | | | | |
| 1 | 136 | 1 | QPSK | 0 | 43200 | 0 |
| 2 | 176 | 1 | QPSK | 0 | | |
| 3 | 232 | 1 | QPSK | 0 | | |
| 4 | 320 | 1 | QPSK | 0 | | |
| 5 | 376 | 1 | QPSK | 0 | | |
| 6 | 464 | 1 | QPSK | 0 | | |
| 7 | 648 | 2 | QPSK | 0 | | |
| 8 | 792 | 2 | QPSK | 0 | | |
| 9 | 928 | 2 | QPSK | 0 | | |
| 10 | 1264 | 3 | QPSK | 0 | | |
| 11 | 1488 | 3 | QPSK | 0 | | |
| 12 | 1744 | 3 | QPSK | 0 | | |
| 13 | 2288 | 4 | QPSK | 0 | | |
| 14 | 2592 | 4 | QPSK | 0 | | |
| 15 | 3328 | 5 | QPSK | 0 | | |
| 16 | 3576 | 5 | 16-QAM | 0 | | |
| 17 | 4200 | 5 | 16-QAM | 0 | | |
| 18 | 4672 | 5 | 16-QAM | 0 | | |
| 19 | 5296 | 5 | 16-QAM | 0 | | |
| 20 | 5896 | 5 | 16-QAM | 0 | | |
| 21 | 6568 | 5 | 16-QAM | 0 | | |
| 22 | 7184 | 5 | 16-QAM | 0 | | |
| 23 | 9736 | 7 | 16-QAM | 0 | | |
| 24 | 11432 | 8 | 16-QAM | 0 | | |
| 25 | 14424 | 10 | 16-QAM | 0 | | |
| 26 | 15776 | 10 | 64-QAM | 0 | | |
| 27 | 21768 | 12 | 64-QAM | 0 | | |
| 28 | 26504 | 13 | 64-QAM | 0 | | |
| 29 | 32264 | 14 | 64-QAM | 0 | | |
| 30 | 38576 | 15 | 64-QAM | 0 | | |

As a second example, ƒ( ) is a measure of the control channel demodulation quality, such as a bit error rate (BER), block error rate (BLER) or packet error rate (PER) of broadcast channel, shared downlink control channel, or downlink control information channel.

As a third example, θ( ) is a measure of the data channel SINR (‘effective SINR’, ‘post-receiver SINR’). A certain transmission scheme, e.g., transmit diversity, could be assumed in calculating γ. The post-processing signal quality can be combined over the receive antennas as well as averaged across the system bandwidth and over time. The calculation of effective SINR is a matter of implementation and examples of such calculation can be easily found in existing literature.

The calculation of the post-processing signal quality may take battery power and processing power of the UE. In some implementations, the calculation of the post-processing signal quality can be configured that only when the UE is at the edge of the pico cell, e.g., moving into or out of a pico cell, the post-processing signal quality reporting may be used. In some other implementations, the UE could determine the post-processing signal quality internally and under certain circumstances, the UE could deliver this information in the MAC (Medium Access Control) CE (Control Element) to the network, similar to power headroom reporting. The network may combine this information with the regular RSRP, RSRQ, RSCP, Ec/I0 or pathloss reporting information to make the handover decision. To increase the reliability, this information reporting may be repeated multiple times. In this way, the current measurement/mobility procedure may not need to be changed. The network could have one more piece of new information to help the mobility in the HetNet or small cell environments.

In some implementations, when the UE moves from the macro into the pico RE area and measures the post-processing signal quality from the pico cell, the measurement may be performed during the ABS since the UE may be scheduled in ABS after being handed into the pico RE area. The UE can reuse the time domain measurement resource restriction such as defined in Rel-10 eICIC, i.e., the UE measures the post-processing signal quality of the pico cell in the subframes specified in MeasSubframePatternConfigNeigh in IE MeasObjectEUTRA. Similarly, when the UE moves from the pico RE area into macro, the measurement of the post-processing signal quality from the serving pico cell may be performed during ABS, e.g., the subframes specified in measSubframePatternPCell in IE RadioResourceConfigDedicated.

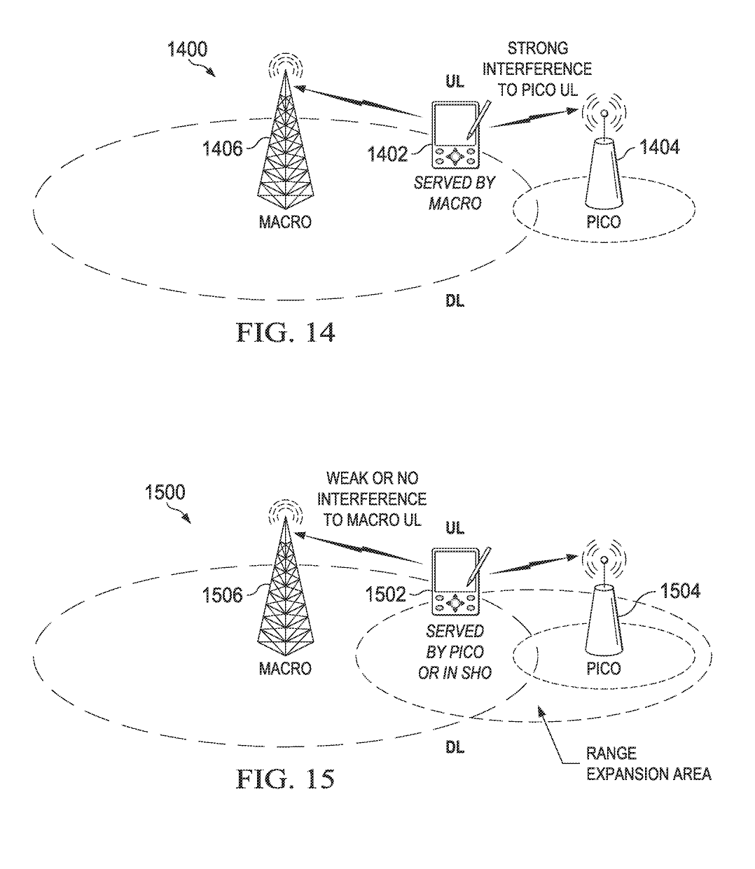

Using post-signal processing metric for RRM decisions may help, among other things, reduce uplink (DL) interference in a HetNet scenario. For example, FIG. 14 is a schematic block diagram 1400 illustrating an example HetNet scenario. In the illustrated example, a UE 1402 is located in proximity of a pico cell 1404. The UE 1402 may be equipped with an advanced receiver. According to state-of-the-art RRM (for example, based on pre-processing signal quality), the UE may be attached to a macro cell 1406. Because the UE 1402 is closer to the pico base station 1404 than the macro base station 1406, the UE 1402 can generate very strong interference towards the pico cell 1404 in UL. If the post-processing metric is used, the RRM decision can be made based on an effective signal quality perceived by the UE 1402. FIG. 15 is a schematic block diagram 1500 illustrating an example HetNet scenario where the post-processing metric is used for the RRM decision. In this illustrated example, the UE 1502 can be instead attached to the pico base station 1504, or in soft handover between the macro base station 1506 and pico base station 1504. Because the UE is attached to the nearby pico base station 1504, possibly lower UL transmission power is needed and thus only weak or no interference is introduced to the farther macro base station 1506. In either case, the UL interference problem can be solved.

In some implementations, using the post-processing metric may help improve mobility management, especially in scenarios where low power network nodes (micro, pico, femto etc.) are deployed. Because the coverage area of the low power network nodes may be significantly smaller than the coverage area of macro nodes, the time available for handover and/or reselection can be reduced compared to that of the macro nodes. With an advanced receiver, monitoring post-processing signal quality may help increase the available time window for the handover decision. In some implementations, monitoring post-processing signal quality can detect a neighbor cell sooner since the post-processing can better capture the actual UE radio environment than some state-of-the-art measurements. Additionally or alternatively, the current serving cell can be monitored for a longer period, and thus again help increase the available time window for the handover decision.

In some implementations, for example, in LTE or UTRAN, post-processing signal quality reports can be configured with very high frequency (less than every 10 ms), providing more up-to-date information on UE radio environment, compared with pre-processing reports whose reporting interval may span tens of milliseconds. As an example, for intra-freq neighbor cell, frequent neighbor cell post-processing measurement can be carried out at the cost of UE processing. For inter-freq or inter-RAT NC (neighbor cell), NC post-processing measurement may be less frequent due to measurement gaps.

Triggering UE measurement report based at least in part on post-processing signal quality could be applied to other scenarios. For example, a small cell is deployed in the coverage of a macro cell and the small cell and the macro cell are on the same frequency. When a fast-moving UE passes the small cell, the UE may not need to be handed into the small cell if the advanced receiver at the UE can suppress the interference from the small cell and achieve sufficient post-processing SINR. In this case if the UE is configured to trigger measurement report based on post-processing signal quality, the UE may not trigger measurement report if the post-processing SINR from the macro cell is acceptable and hence the handover can be eliminated. This can reduce unnecessary handovers and improve the user experience.

While several implementations have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented. Variations, modifications, and enhancements to the described examples and implementations and other implementations can be made based on what is disclosed.

Also, techniques, systems, subsystems and methods described and illustrated in the various implementations as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

While the above detailed description has shown, described, and pointed out the fundamental novel features of the disclosure as applied to various implementations, it will be understood that various omissions and substitutions and changes in the form and details of the system illustrated may be made by those skilled in the art, without departing from the intent of the disclosure.

What is claimed is:

1. A method performed at a user equipment (UE) of a wireless communications network, the method comprising:
receiving a reference signal;
identifying a post-processing metric based at least in part on the received reference signal; and
triggering a mobility event based at least in part on the post-processing metric.

2. The method of claim 1, further comprising informing the network that the UE is capable of identifying the post-processing metric.

3. The method of claim 1, further comprising receiving an indication from the network to use the post-processing metric to trigger the mobility event.

4. The method of claim 1, wherein triggering the mobility event comprises the UE performing cell selection or reselection.

5. The method of claim 1, wherein triggering the mobility event comprises performing a handover procedure.

6. The method of claim 1, wherein the post-processing metric represents a performance of a receiver processing algorithm.

7. The method of claim 6, wherein the receiver processing algorithm comprises at least one of a Maximum Ration Combining (MRC) algorithm, a Minimum Mean Square Error (MMSE) algorithm, a MMSE-Interference Rejection Combining (MMSE-IRC) algorithm, an Interference Cancellation (IC) algorithm, or a Rake algorithm.

8. The method of claim 6, wherein the receiver processing algorithm fulfills requirements corresponding to at least one of enhanced receiver type 1, 2, 3, or 3i.

9. The method of claim 1, wherein the post-processing metric represents a signal quality of a combination of signals from one or more receiver antenna ports of the UE.

10. The method of claim 9, wherein the combination of signals represents an optimization based on a cost function, the cost function including an inter-cell interference suppression criteria.

11. The method of claim 1, wherein triggering the mobility event comprises:
identifying a measurement report trigger event based at least in part on the post-processing metric;
generating a measurement report; and
transmitting the measurement report to the network.

12. The method of claim 11, wherein the measurement report includes the post-processing metric.

13. The method of claim 12, wherein the measurement report trigger event is one of a Type I event or a Type II event.

14. The method of claim 13, wherein the Type I event is triggered when a signal quality of a serving cell of the UE becomes worse than a threshold.

15. The method of claim 13, wherein the Type II event is triggered when a signal quality of a neighboring cell of the UE exceeds a threshold.

16. The method of claim 11, further comprising:
receiving, from the network, control information instructing the UE to include one or more neighboring cell measurements into the measurement report;
including the one or more neighboring cell measurements into the measurement report; and
transmitting the measurement report to a network node.

17. The method of claim 1, wherein identifying a post-processing metric based on the received reference signal comprises measuring a signal quality based on the received reference signal based at least in part on one or more of an estimated channel response between a transmit and receive antenna pair, interference statistics, a block error rate, or a transmission mode.

18. The method of claim 1, wherein the post-processing metric is at least one or more of a measure of traffic channel spectral efficiency, a measure of control channel demodulation quality, a measure of reference signal or data channel Signal to Interference plus Noise Ratio (SINR), or a Channel Quality Indicator (CQI).

19. The method of claim 1, wherein the reference signal is received during a subset of subframes.

20. The method of claim 19, wherein the subset of subframes is one of Almost Blank Subframes (ABS) and MBSFN.

21. The method of claim 1, further comprising processing the received reference signal to identify the post-processing metric.

22. A user equipment (UE) of a wireless communications network, the UE operable to:
receive a reference signal;
identify a post-processing metric based at least in part on the received reference signal; and
trigger a mobility event based at least in part on the post-processing metric.

23. The UE of claim 22, further operable to inform the network that the UE is capable of identifying the post-processing metric.

24. The UE of claim 22, further operable to receive an indication from the network to use the post-processing metric to trigger the mobility event.

25. The UE of claim 22, wherein triggering the mobility event comprises the UE performing cell selection or reselection.

26. The UE of claim 22, wherein the mobility event comprises performing a handover procedure.

27. The UE of claim 22, wherein the post-processing metric represents a performance of a receiver processing algorithm.

28. The UE of claim 27, wherein the receiver processing algorithm comprises at least one of a Maximum Ration Combining (MRC) algorithm, a Minimum Mean Square Error (MMSE) algorithm, a MMSE-Interference Rejection Combining (MMSE-IRC) algorithm, an Interference Cancellation (IC) algorithm, or a Rake algorithm.

29. The UE of claim 27, wherein the receiver processing algorithm fulfills requirements corresponding to at least one of enhanced receiver type 1, 2, 3, 3i.

30. The UE of claim 26, wherein the post-processing metric represents a signal quality of a combination of signals from one or more receiver antenna ports of the UE.

31. The UE of claim 30, wherein the combination of signals represents an optimization based on a cost function, the cost function including an inter-cell interference suppression criteria.

32. The UE of claim 22, wherein triggering the mobility event comprises:
identifying a measurement report trigger event based at least in part on the post-processing metric;
generating a measurement report; and
transmitting the measurement report to the network.

33. The UE of claim 32, wherein the measurement report includes the post-processing metric.

34. The UE of claim 33, wherein the measurement report trigger event is one of a Type I event or a Type II event.

35. The UE of claim 34, wherein the Type I event is triggered when a signal quality of a serving cell of the UE becomes worse than a threshold.

36. The UE of claim 34, wherein the Type II event is triggered when a signal quality of a neighboring cell of the UE exceeds a threshold.

37. The UE of claim 32, further operable to:
receive, from the network, control information instructing the UE to include one or more neighboring cell measurements into the measurement report;
include the one or more neighboring cell measurements into the measurement report; and
transmit the measurement report to a network node.

38. The UE of claim 22, wherein identifying a post-processing metric based on the received reference signal comprises measuring a signal quality based on the received reference signal based at least in part on one or more of an estimated channel response between a transmit and receive antenna pair, interference statistics, a block error rate, or a transmission mode.

39. The UE of claim 22, wherein the post-processing metric is at least one or more of a measure of traffic channel spectral efficiency, a measure of control channel demodulation quality, a measure of reference signal or data channel Signal to Interference plus Noise Ratio (SINR), or a Channel Quality Indicator (CQI).

40. The UE of claim 22, wherein the reference signal is received during a subset of subframes.

41. The UE of claim 40, wherein the subset of subframes is one of Almost Blank Subframes (ABS) and MBSFN.

42. The UE of claim 22, further operable to process the received reference signal to identify a post-processing metric.

43. A method performed at a network node of a wireless communications network, the method comprising:
transmitting a reference signal to a user equipment (UE) of the network, wherein the UE is capable of identifying a post-processing metric based at least in part on the transmitted reference signal; and
receiving, from the UE, an indication of a mobility event, wherein the mobility event is triggered based at least in part on the post-processing metric.

44. The method of claim 43, further comprising receiving an indication from the UE that the UE is capable of identifying the post-processing metric.

45. The method of claim 43, further comprising transmitting, to the UE, an indication instructing the UE to use the post-processing metric to trigger the mobility event.

46. The method of claim 43, wherein the mobility event comprises a cell selection or reselection event.

47. The method of claim 43, wherein the mobility event comprises performing a handover procedure.

48. The method of claim 43, wherein the post-processing metric represents at least one or more of a performance of a receiver processing algorithm, a signal quality of a combination of signals from one or more receiver antenna ports of the UE, or an optimization based on a cost function, the cost function including an inter-cell interference suppression criteria.

49. The method of claim 43, wherein the mobility event is a measurement report trigger event and the indication comprises a measurement report.

50. The method of claim 49, further comprising making a handover decision based at least in part on the measurement report.

51. The method of claim 49, wherein the measurement report trigger event is one of a Type I event or a Type II event.

52. The method of claim 51, wherein the Type I event is triggered when a signal quality of a serving cell of the UE becomes worse than a threshold.

53. The method of claim 51, wherein the Type II event is triggered when a signal quality of a neighboring cell of the UE becomes better than a threshold.

54. The method of claim 49, further comprising transmitting control information instructing the UE to include one or more neighboring cell measurements into the measurement report.

55. The method of claim 43, wherein the reference signal is transmitted during a subset of subframes.

56. The method of claim 55, wherein the subset of subframes is one of Almost Blank Subframes (ABS) and MBSFN.
